(19) United States
(12) Patent Application Publication
(10) Pub. No.: US 2026/0094556 A1
(43) Pub. Date: Apr. 2, 2026

(54) Display Device

(71) Applicant: LG Display Co., Ltd., Seoul (KR)

(72) Inventors: Daeyoung Seo, Seoul (KR); ByungHyun Lee, Paju-si (KR); TaeYong Kim, Anyang-si (KR); Sumin Lee, Seoul (KR)

(21) Appl. No.: 19/241,839

(22) Filed: Jun. 18, 2025

(30) Foreign Application Priority Data
Sep. 27, 2024 (KR) 10-2024-0131844

(51) Int. Cl. G09G 3/20

(52) U.S. Cl. CPC G09G 3/2092; G09G 2300/0426; G09G 2310/0267; G09G 2310/0291; G09G 2330/023

(57) ABSTRACT

Provided is a display device. The display device includes a plurality of pixel groups including a plurality of pixels disposed in a row direction, a plurality of gate lines connected to the plurality of pixel groups, a gate driver which supplies an output signal, an output line connected to the gate driver and a plurality of MUX units connected between the plurality of gate lines and the output line.

### CROSS-REFERENCE TO RELATED APPLICATION

This application claims the priority of Republic of Korea Patent Application No. 10-2024-0131844 filed on Sep. 27, 2024, which is hereby incorporated by reference in its entirety.

### BACKGROUND

### Field

The present disclosure relates to a display device, and more particularly, to a display device in which a size of a gate driver is reduced.

### Description of the Related Art

Generally, display devices are widely used as display screens for various electronic devices, such as mobile communication terminals, electronic notebooks, electronic books, portable multimedia players (PMPs), navigation, ultra mobile personal computers (UMPC), mobile phones, smart phones, tablet personal computers (PCs), watch phones, electronic pads, wearable devices, portable information devices, vehicle control display devices, televisions, laptops, and monitors.

Recently, display devices which implement a maximum screen by reducing a bezel area in which images are not displayed with the same size of the display panel are being studied and developed.

### SUMMARY

An object to be achieved by the present disclosure is to provide a display device which increases transparency of a bezel area and increases a degree of freedom of design in the bezel area.

An object to be achieved by the present disclosure is to provide a display device in which a bezel area is minimized.

An object to be achieved by the present disclosure is to provide a display device which minimizes or at least reduces power consumption.

Objects of the present disclosure are not limited to the above-mentioned objects, and other objects, which are not mentioned above, can be clearly understood by those skilled in the art from the following descriptions.

According to an embodiment of the present disclosure, a display device includes a plurality of pixel groups including a plurality of pixels disposed in a row direction, a plurality of gate lines connected to the plurality of pixel groups, a gate driver which supplies an output signal, an output line connected to the gate driver and a plurality of MUX units connected between the plurality of gate lines and the output line.

Other detailed matters of the exemplary embodiments are included in the detailed description and the drawings.

According to the present disclosure, in the display device, the number of stages of a gate driver disposed in the bezel area may be reduced to increase transparency and a degree of freedom of design of the bezel area and increase a PPI.

According to the present disclosure, in the display device, a size of a gate driver disposed in the bezel area is minimized to minimize the bezel area.

According to the present disclosure, the display device is driven with a low resolution to be driven at a low power so that the power consumption may be reduced.

The effects according to the present disclosure are not limited to the contents exemplified above, and more various effects are included in the present specification.

### BRIEF DESCRIPTION OF DRAWINGS

The above and other embodiment, features and other advantages of the present disclosure will be more clearly understood from the following detailed description taken in conjunction with the accompanying drawings, in which:

FIG. 1 is a block diagram of a display device according to an exemplary embodiment of the present disclosure;

FIG. 2 is a circuit diagram illustrating a gate driver and a multiplexor (MUX) unit of a display device according to an exemplary embodiment of the present disclosure;

FIG. 3 is a waveform chart illustrating signals which are input and output to and from a gate driver and a MUX unit of a display device according to an exemplary embodiment of the present disclosure;

FIG. 4 is a waveform chart illustrating signals which are input and output to and from a gate driver and a MUX unit of a display device according to another exemplary embodiment of the present disclosure;

FIG. 5 is a circuit diagram illustrating a gate driver, a MUX unit, and a switching unit of a display device according to still another exemplary embodiment of the present disclosure;

FIG. 6 is a waveform chart illustrating signals which are input and output to and from a gate driver, a MUX unit, and a switching unit of FIG. 5 according to an exemplary embodiment of the present disclosure;

FIG. 7 is a circuit diagram illustrating a gate driver, a MUX unit, and a switching unit of a display device according to still another exemplary embodiment of the present disclosure;

FIG. 8 is a waveform chart illustrating signals which are input and output to and from a gate driver, a MUX unit, and a switching unit of FIG. 7 according to an exemplary embodiment of the present disclosure;

FIG. 9 is a circuit diagram illustrating a gate driver, a MUX unit, and a switching unit of a display device according to still another exemplary embodiment of the present disclosure;

FIG. 10 is a waveform chart illustrating signals which are input and output to and from a gate driver, a MUX unit, and a switching unit of FIG. 9; and

FIG. 11 is a circuit diagram illustrating a gate driver, a MUX unit, and a switching unit of a display device according to still another exemplary embodiment of the present disclosure.

### DETAILED DESCRIPTION

Advantages and characteristics of the present disclosure and a method of achieving the advantages and characteristics will be clear by referring to exemplary embodiments described below in detail together with the accompanying drawings. However, the present disclosure is not limited to the exemplary embodiments disclosed herein but will be implemented in various forms. The exemplary embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “comprising” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately”or “directly”.

When explaining temporal relationships, terms such as “after,” “following,” “subsequent to,” or “before,” etc., may include non-consecutive cases unless terms like “immediately” or “directly” are used.

Terms such as “first,” “second,” etc. are used to describe various components, but these components are not limited by these terms. These terms are merely used to distinguish one component from another. Therefore, a first component mentioned herein could be a second component within the technical scope of the present disclosure.

In describing the components of the present disclosure, terms such as first, second, A, B, (a), or (b) may be used. These terms are only intended to distinguish that one component from other components, and the nature, order, sequence, or number of the respective component is not limited by these terms.

When a component is described as being “connected,” “coupled,” “joined,” or “attached” to another component, it should be understood that the component may be directly connected, coupled, joined, or attached to the other component, but unless explicitly specified otherwise, it may also be indirectly connected, coupled, joined, or attached with another component intervening between each component.

When a component or layer is described as being “in contact with” or “overlapping” another component or layer, the component or layer may directly contact or overlap the other component or layer, but unless explicitly specified otherwise, it should be understood that it may also indirectly contact or overlap with another component intervening between each component.

The term “at least one” should be understood to include all combinations of one or more of the associated components. For example, “at least one of first, second, and third components” means not only the first, second, or third component, but also includes all combinations of two or more components from among the first, second, and third components.

The terms “first direction”, “second direction”, “third direction”, “X-axis direction”, “Y-axis direction”, and “Z-axis direction” should not be interpreted solely as geometric relationships perpendicular to each other, but may indicate broader directionality within the range where the configuration of the present disclosure can function.

The features of various embodiments in the present disclosure may be partially or wholly combined or associated with each other, various technical interlocking and operations are possible, and each embodiment may be implemented independently of each other or may be implemented together in an associated relationship.

Hereinafter, a display apparatus according to exemplary embodiments of the present disclosure will be described in detail with reference to accompanying drawings.

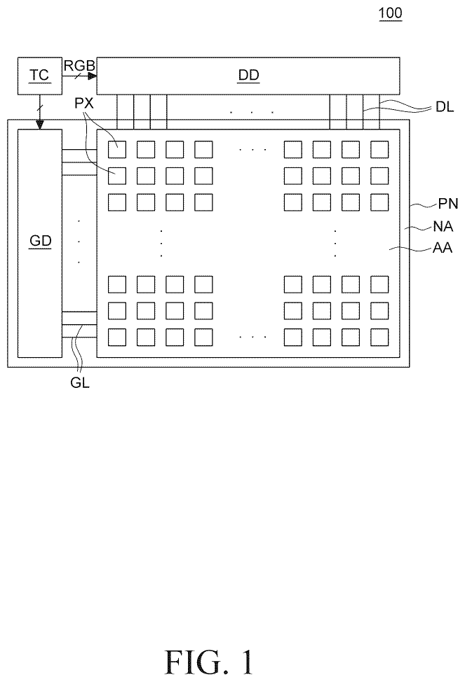

FIG. 1 is a block diagram of a display device according to an exemplary embodiment of the present disclosure.

Referring to FIG. 1, a display device 100 according to the exemplary embodiment of the present disclosure includes a display panel PN, a timing controller TC, a data driver DD, and a gate driver GD.

The display panel PN includes an active area AA in which an image is displayed and a non-active area NA which is disposed at the outside of the active area AA. Various signal lines and a gate driver GD are disposed in the non-active area NA.

In the active area AA, a plurality of pixels PX may be disposed to display images.

In the active area AA, a plurality of gate lines GL disposed in a first direction and a plurality of data lines DL disposed in a second direction which is different from the first direction may be disposed. The plurality of gate lines GL and the plurality of data lines DL may intersect and the plurality of pixels PX may be disposed in a matrix.

The plurality of pixels PX may be electrically connected to the plurality of gate lines GL and the plurality of data lines DL. Therefore, a gate voltage and a data voltage may be applied to each pixel PX through the gate lines GL and the data lines DL. Each pixel PX implements a gray scale by the gate voltage and the data voltage to display the image in the active area AA.

One pixel PX may include a plurality of sub pixels which emits different color light. For example, the pixel PX uses three sub pixels to implement blue, red, and green. However, this is not limited thereto and in some cases, the pixel PX may further include a sub pixel for further implementing a specific color (for example, white).

In the pixel PX, an area which implements blue may be referred to as a blue sub pixel, an area which implements red may be referred to as a red sub pixel, and an area which implements green may be referred to as a green sub pixel.

One data line DL and one gate line GL may be connected to each of the plurality of pixels.

The timing controller TC may transmit an input image signal RGB received from a host system to the data driver DD.

The timing controller TC may generate a control signal for controlling an operation timing of the gate driver GD and the data driver DD using a timing signal, such as a clock signal, a horizontal synchronization signal, a vertical synchronization signal, and a data enable signal which are received together with image data RGB. Here, the horizontal synchronization signal is a signal representing a time taken to display one horizontal line of a screen and the vertical synchronization signal is a signal representing a time taken to display a screen of one frame. The data enable signal is a signal representing a period when a data voltage is supplied to a pixel PX defined in the display panel PN.

In other words, the timing controller TC is applied with a timing signal to output a gate control signal to the gate driver GD and output a data control signal to the data driver DD.

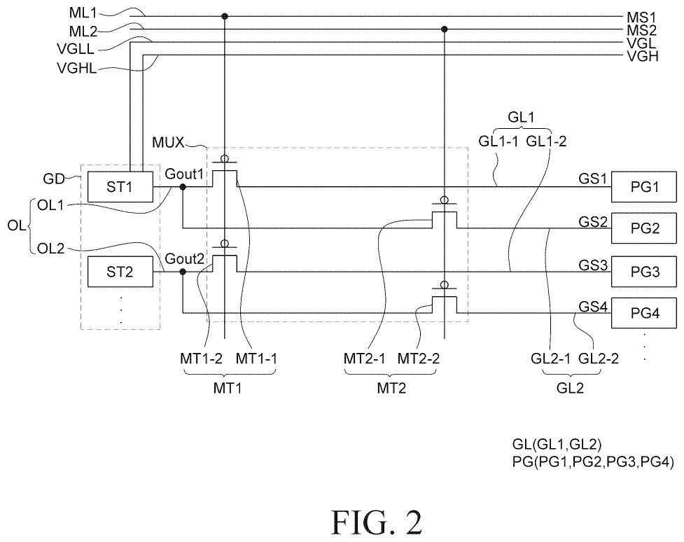

The timing controller TC may output a MUX signal which controls the operation of the MUX unit (MUX of FIG. 2) using the control signal received from the host system.

The data driver DD is applied with the data control signal to output a data voltage to the data line DL.

Specifically, the data driver DD may generate a sampling signal in accordance with the data control signal and latch the image data RGB in accordance with the sampling signal to be converted into a data voltage and then supply the data voltage to the data line DL in response to a source output enable (SOE) signal.

The data driver DD may be connected to the bonding pad of the display panel PN in a chip on glass (COG) manner or may be directly disposed on the display panel PN. In some cases, the data driver DD may be disposed to be integrated with the display panel PN. Further, the data driver DD may be disposed in a chip on film (COF) manner.

The gate driver GD sequentially supplies a scan signal and an emission signal corresponding to the gate signal to the gate line GL, in accordance with the gate control signal.

The gate driver GD is formed independently from the display panel PN to be electrically connected to the display panel PN in various ways. However, the gate driver GD of the display device 100 according to the exemplary embodiment of the present disclosure is formed to have a thin film pattern when a substrate of the display panel PN is manufactured to be embedded on the non-active area NA in a gate in panel (GIP) manner. The gate driver GD may be disposed on one side of the display panel PN. However, the present disclosure is not limited thereto and the gate driver GD may be separately disposed on both sides of the display panel PN.

The gate driver GD may include a plurality of scan driving stages which outputs a plurality of scan signals to the plurality of pixels PX and a plurality of emission driving stages which outputs a plurality of emission signals to the plurality of pixels PX.

FIG. 2 is a circuit diagram illustrating a gate driver and a MUX unit of a display device according to an exemplary embodiment of the present disclosure. In FIG. 2, for the convenience of description, a gate driver GD, a plurality of pixel groups PG, a multiplexor (MUX) unit MUX, an output line OL, a first gate line GL1, and a second gate line GL2 are illustrated. In the meantime, even though in FIG. 2, for the convenience of description, a plurality of pixel groups PG disposed in four rows is illustrated, the plurality of pixel groups PG disposed in four rows which is described in FIG. 2 may be repeatedly disposed in a column direction.

A transistor which is described in FIG. 2 may include a first electrode, a second electrode, and a gate electrode. One of the first electrode and the second electrode may be a source electrode and the other one of the first electrode and the second electrode may be a drain electrode. The transistor may be a P-type thin film transistor or an N-type thin film transistor. In FIG. 2, the transistor is configured as a P-type thin film transistor, but it is not limited thereto. Further, the N-type thin film transistor may be an oxide thin film transistor and the P-type thin film transistor may be a polycrystalline silicon thin film transistor, but they are not limited thereto.

Hereinafter, it is described that the transistor is a P-type thin film transistor as an example. Accordingly, the transistor is applied with a gate low voltage to be turned on.

Referring to FIG. 2, a plurality of pixel groups PG are disposed in the active area AA of the display device 100 according to the exemplary embodiment of the present disclosure. In each of the plurality of pixel groups PG, a plurality of pixels PX which are adjacent to each other in a row direction and are commonly connected to the same gate line may be disposed. Here, the pixel group PG may refer to a set of pixels PX in one line which is connected to one gate line GL disposed in the row direction. The plurality of pixel groups PG may be disposed in the order of a first pixel group PG1, a second pixel group PG2, a third pixel group PG3, and a fourth pixel group PG4 from the first row. For example, the first pixel group PG1 may be a set of pixels PX disposed in a first row, the second pixel group PG2 may be a set of pixels PX disposed in a second row, the third pixel group PG3 may be a set of pixels PX disposed in a third row, and the fourth pixel group PG4 may be a set of pixels PX disposed in a fourth row.

The plurality of gate lines GL may include a plurality of first gate lines GL1 and a plurality of second gate lines GL2.

The plurality of first gate lines GL1 are connected to the first pixel group PG1 and the third pixel group PG3 which are the set of pixels PX disposed in odd-numbered rows to supply a gate signal. For example, the plurality of first gate lines GL1 may include a 1-1-th gate line GL1-1 and a 1-2-th gate line GL1-2. For example, the 1-1-th gate line GL1-1 is connected to the first pixel group PG1 to supply a first gate signal GS1 and the 1-2-th gate line GL1-2 is connected to the third pixel group PG3 to supply a third gate signal GS3.

The plurality of second gate lines GL2 are connected to the second pixel group PG2 and the fourth pixel group PG4 which are the set of pixels PX disposed in even-numbered rows to supply a gate signal. For example, the plurality of second gate lines GL2 may include a 2-1-th gate line GL2-1 and a 2-2-th gate line GL2-2. For example, the 2-1-th gate line GL2-1 is connected to the second pixel group PG2 to supply a second gate signal GS2 and the 2-2-th gate line GL2-2 is connected to the fourth pixel group PG4 to supply a fourth gate signal GS4.

The gate driver GD may be implemented as a gate shift register which is configured by a plurality of stages ST. The plurality of stages ST may generate and output the output signal. The plurality of stages ST may receive an external start signal, a plurality of clock signals, a gate high voltage VGH which is a gate off voltage, and a gate low voltage VGL which is a gate on voltage to output the output signal. However, the present disclosure is not limited thereto and in the case of the N-type transistor, the gate high voltage VGH may be a gate on voltage and the gate low voltage VGL may be a gate off voltage.

For example, referring to FIG. 2, the gate driver GD may be connected to a gate high voltage line VGHL which is supplied with a gate high voltage VGH and a gate low voltage line VGLL which is supplied with a gate low voltage VGL.

The plurality of stages ST are sequentially activated according to the start signal to output the output signal. The plurality of stages ST may be a plurality of scan driving stages and a plurality of emission driving stages.

For example, the plurality of stages ST may be disposed in the order of a first stage ST1 and a second stage ST2 from a stage located at the top. However, even though for the convenience of description in FIG. 2, it is illustrated that the gate driver GD is configured by only the first stage ST1 and the second stage ST2, the gate drivers may be repeatedly disposed in the column direction.

An operation of the first stage ST1 is activated according to an external start signal and operations of the second stage ST2 to the lowest stage are activated according to an output signal output from a previous stage. The output signal of the previous stage is an internal start signal and may be a carry signal. Here, the “previous stage” may refer to a stage which is located above a reference stage to generate an output signal which has a phase earlier than an output signal output from the reference stage.

A plurality of output lines OL which output an output signal may be connected to each of the plurality of stages ST. The plurality of output lines OL may include a first output line OL1 and a second output line OL2. For example, referring to FIG. 2, the first output line OL1 is connected to an output terminal of the first stage ST1 to output a first output signal Gout1 to the first output line OL1. The second output line OL2 is connected to an output terminal of the second stage ST2 to output a second output signal Gout2 to the second output line OL2.

The MUX unit MUX may be connected between the plurality of stages ST and the plurality of pixel groups PG. Specifically, the MUX unit MUX may be connected between the plurality of gate lines GL and the plurality of output lines OL. The MUX unit MUX may receive output signals Gout1 and Gout2 output from the plurality of stages ST and output a gate signal to the plurality of gate lines GL in accordance with a first MUX signal MS1 and a second MUX signal MS2 which are applied through the plurality of MUX signal lines ML.

The MUX unit MUX may include a plurality of first MUX transistors MT1 and a plurality of second MUX transistors MT2.

Each of the plurality of first MUX transistors MT1 and the plurality of second MUX transistors MT2 may include a first electrode, a second electrode, and a gate electrode. One of the first electrode and the second electrode may be a source electrode and the other one of the first electrode and the second electrode may be a drain electrode. Each of the plurality of first MUX transistors MT1 and the plurality of second MUX transistors MT2 may be P-type thin film transistors or N-type thin film transistors. In FIG. 2, the plurality of first MUX transistors MT1 and the plurality of second MUX transistors MT2 are configured as P-type thin film transistors, but it is not limited thereto. Further, the N-type thin film transistor may be an oxide thin film transistor and the P-type thin film transistor may be a polycrystalline silicon thin film transistor, but they are not limited thereto.

Hereinafter, it will be described that the plurality of first MUX transistors MT1 and the plurality of second MUX transistors MT2 are P-type thin film transistors. Accordingly, a gate low voltage is applied to the plurality of first MUX transistors MT1 and the plurality of second MUX transistors MT2 to be turned on.

The plurality of first MUX transistors MT1 may include a 1-1-th MUX transistor MT1-1 and a 1-2-th MUX transistor MT1-2.

The 1-1-th MUX transistor MT1-1 may be connected between the first output line OL1 and the 1-1-th gate line GL1-1. For example, the 1-1-th MUX transistor MT1-1 may include a first electrode connected to the first output line OL1, a second electrode connected to a 1-1-th gate line GL1-1, and a gate electrode connected to a first MUX signal line ML1 which supplies a first MUX signal MS1.

The 1-2-th MUX transistor MT1-2 may be connected between the second output line OL2 and the 1-2-th gate line GL1-2. For example, the 1-2-th MUX transistor MT1-2 may include a first electrode connected to the second output line OL2, a second electrode connected to a 1-2-th gate line GL1-2, and a gate electrode connected to the first MUX signal line ML1 which supplies a first MUX signal MS1.

The plurality of second MUX transistors MT2 may include a 2-1-th MUX transistor MT2-1 and a 2-2-th MUX transistor MT2-2.

The 2-1-th MUX transistor MT2-1 may be connected between the first output line OL1 and the 2-1-th gate line GL2-1. For example, the 2-1-th MUX transistor MT2-1 may include a first electrode connected to the first output line OL1, a second electrode connected to a 2-1-th gate line GL2-1, and a gate electrode connected to a second MUX signal line ML2 which supplies a second MUX signal MS2.

The 2-2-th MUX transistor MT2-2 may be connected between the second output line OL2 and the 2-2-th gate line GL2-2. For example, the 2-2-th MUX transistor MT2-2 may include a first electrode connected to the second output line OL2, a second electrode connected to a 2-2-th gate line GL2-2, and a gate electrode connected to a second MUX signal line ML2 which supplies a second MUX signal MS2.

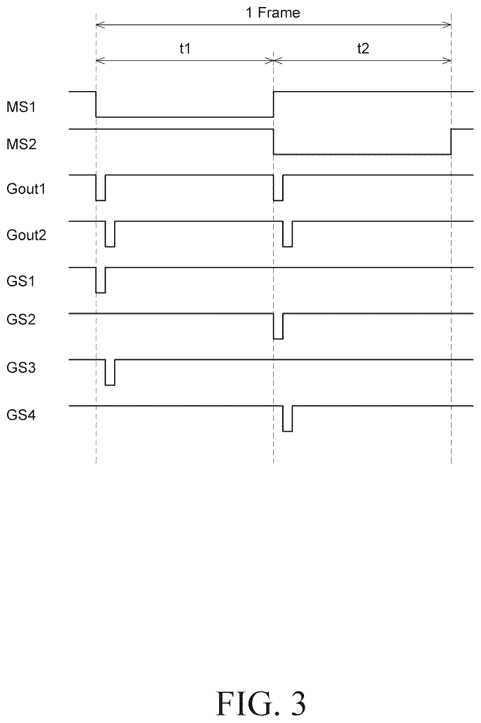

FIG. 3 is a waveform chart illustrating signals which are input and output to and from a gate driver and a MUX unit of a display device according to an exemplary embodiment of the present disclosure.

Referring to FIG. 3, one frame may include a first period t1 and a second period t2. The first period t1 and the second period t2 are periods obtained by dividing one frame by a predetermined time. For example, the first period t1 and the second period t2 may be periods obtained by dividing one frame by a ½. In one frame, the gate driver GD may output the plurality of first output signals Gout1 and the plurality of second output signals Gout2. For example, the gate driver GD may output one first output signal Gout1 and one second output signal Gout2 in the first period t1 and output one first signal Gout1 and one second output signal Gout2 in the second period t2.

Referring to FIGS. 2 and 3, in the first period t1, the first MUX signal MS1 is a low voltage and the second MUX signal MS2 is a high voltage. In this case, the 1-1-th MUX transistor MT1-1 and the 1-2-th MUX transistor MT1-2 are turned on and the 2-1-th MUX transistor MT2-1 and the 2-2-th MUX transistor MT2-2 are turned off.

Therefore, the 1-1-th MUX transistor MT1-1 connects the first output line OL1 and the 1-1-th gate line GL1-1 to output the first output signal Gout1 which is input through the first output line OL1 to the 1-1-th gate line GL1-1 as a first gate signal GS1. By doing this, the first pixel group PG1 may be supplied with the first gate signal GS1 through the 1-1-th gate line GL1-1. Further, the 1-2-th MUX transistor MT1-2 connects the second output line OL2 and the 1-2-th gate line GL1-2 to output the second output signal Gout2 which is input through the second output line OL2 to the 1-2-th gate line GL1-2 as a third gate signal GS3. By doing this, the third pixel group PG3 may be supplied with the third gate signal GS3 through the 1-2-th gate line GL1-2.

Referring to FIGS. 2 and 3, in the second period t2, the first MUX signal MS1 is a high voltage and the second MUX signal MS2 is a low voltage. In this case, the 1-1-th MUX transistor MT1-1 and the 1-2-th MUX transistor MT1-2 are turned off and the 2-1-th MUX transistor MT2-1 and the 2-2-th MUX transistor MT2-2 are turned on.

Therefore, the 2-1-th MUX transistor MT2-1 connects the first output line OL1 and the 2-1-th gate line GL2-1 to output the first output signal Gout1 which is input through the first output line OL1 to the 2-1-th gate line GL2-1 as a second gate signal GS2. By doing this, the second pixel group PG2 may be supplied with the second gate signal GS2 through the 2-1-th gate line GL2-1. Further, the 2-2-th MUX transistor MT2-2 connects the second output line OL2 and the 2-2-th gate line GL2-2 to output the second output signal Gout2 which is input through the second output line OL2 to the 2-2-th gate line GL2-2 as a fourth gate signal GS4. By doing this, the fourth pixel group PG4 may be supplied with the fourth gate signal GS4 through the 2-2-th gate line GL2-2.

In the existing display device, a plurality of stages which configure the gate driver are connected to the plurality of pixel groups disposed in each row so that the number of pixel groups and the number of stages are equal to each other. Therefore, if the interval between the stages is increased to ensure the transparency of the non-active area in which the gate driver is disposed or the number of pixels disposed in the active area is increased to increase pixels per inch (PPI), the area of the non-active area is inevitably increased so that the bezel is increased.

Therefore, in the display device 100 according to the exemplary embodiment of the present disclosure, the transparency of the bezel area and the degree of freedom of design may be increased and the PPI may be increased. Specifically, the display device 100 according to the exemplary embodiment of the present disclosure includes a MUX unit MUX disposed between the plurality of output lines OL connected to the gate driver GD and the plurality of gate lines GL connected to the plurality of pixel groups PG. The MUX unit MUX includes a first MUX transistor MT1 which is connected between the output line OL and the first gate line GL1 and operates in response to the first MUX signal MS1 and a second MUX transistor MT2 which is connected between the output line OL and the second gate line GL2 and operates in response to the second MUX signal MS2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 100 according to the exemplary embodiment of the present disclosure may supply the output signal output from one stage ST to two gate lines through the MUX unit MUX as gate signals. Therefore, the number of stages disposed in the non-active area is reduced to ½ to increase the transparency and the degree of freedom of design of the bezel area and the gate signal may be applied to two pixel groups by one stage so that the PPI may be increased without adding a stage.

Further, in the display device 100 according to the exemplary embodiment of the present disclosure, the bezel area may be minimized or at least reduced. Specifically, in the display device 100 according to the exemplary embodiment of the present disclosure, the first MUX transistor MT1 is connected between the output line OL connected to the gate driver GD and the first gate line GL1 and the second MUX transistor MT2 is connected between the output line OL and the second gate line GL2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 100 according to the exemplary embodiment of the present disclosure may apply the output signal output from one stage ST to two gate lines through the MUX unit MUX as gate signals so that the size of the gate driver disposed in the bezel area is minimized to minimize the bezel area.

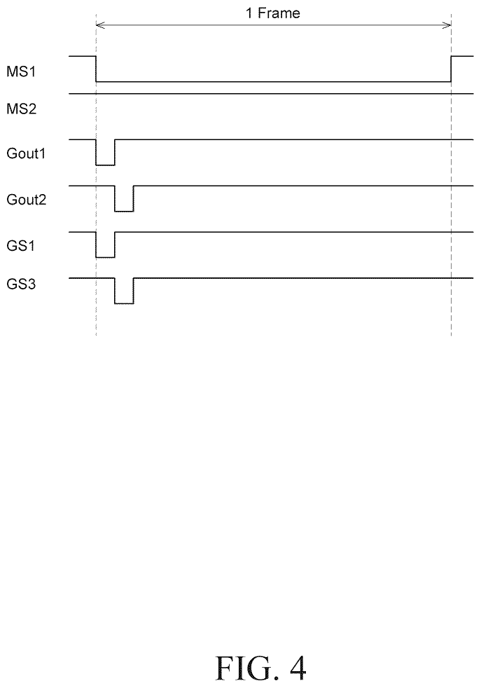

FIG. 4 is a waveform chart illustrating signals which are input and output to and from a gate driver and a MUX unit of a display device according to another exemplary embodiment of the present disclosure. A display device 200 according to another exemplary embodiment of the present disclosure has the same configuration as the display device 100 according to the exemplary embodiment of FIG. 2 so that a redundant description for repeated configurations is omitted. In the display device 200 according to another exemplary embodiment of the present disclosure, when the resolution of the display device 200 is half the resolution of the display device 100 according to the exemplary embodiment of FIGS. 2 and 3, a signal output from the gate driver GD and signals input and output to and from the MUX unit MUX are illustrated.

Referring to FIG. 4, during one frame, the gate driver GD may output one first output signal Gout1 and a plurality of second output signals Gout2.

Referring to FIGS. 2 and 4, during one frame, the first MUX signal MS1 is a low voltage and the second MUX signal MS2 is a high voltage. In this case, the 1-1-th MUX transistor MT1-1 and the 1-2-th MUX transistor MT1-2 are turned on and the 2-1-th MUX transistor MT2-1 and the 2-2-th MUX transistor MT2-2 are turned off.

Therefore, the 1-1-th MUX transistor MT1-1 connects the first output line OL1 and the 1-1-th gate line GL1-1 to output the first output signal Gout1 which is input through the first output line OL1 to the 1-1-th gate line GL1-1 as a first gate signal GS1. By doing this, the first pixel group PG1 may be supplied with the first gate signal GS1 through the 1-1-th gate line GL1-1. Further, the 1-2-th MUX transistor MT1-2 connects the second output line OL2 and the 1-2-th gate line GL1-2 to output the second output signal Gout2 which is input through the second output line OL2 to the 1-2-th gate line GL1-2 as a third gate signal GS3. By doing this, the third pixel group PG3 may be supplied with the third gate signal GS3 through the 1-2-th gate line GL1-2.

Accordingly, the display device 200 according to another exemplary embodiment of the present disclosure is changed to a low resolution to be driven at the low resolution. Specifically, in the display device 200 according to another exemplary embodiment of the present disclosure, the first MUX transistor MT1 is connected between the output line OL connected to the gate driver GD and the first gate line GL1 and the second MUX transistor MT2 is connected between the output line OL and the second gate line GL2. At this time, when the display device is driven by changing the resolution to the low resolution, during the first frame, a low level of first MUX signal MS1 and a high level of second MUX signal MS2 are applied. The first MUX transistor MT1 is turned on and the second MUX transistor MT2 is turned off to connect the output line OL to only the first gate line GL1. That is, the first output signal Gout1 is supplied to the first pixel group PG1 as a first gate signal GS1 and the second output signal Gout2 is supplied to the third pixel group PG3 as a third gate signal GS3. Accordingly, the display device 200 according to another exemplary embodiment of the present disclosure may supply the output signal output from one stage ST to two gate lines through the MUX unit MUX as gate signals. Therefore, the display device may be driven by changing the resolution to the low resolution and the number of stages ST may be reduced so that the display device may be driven at a low power to save the power consumption.

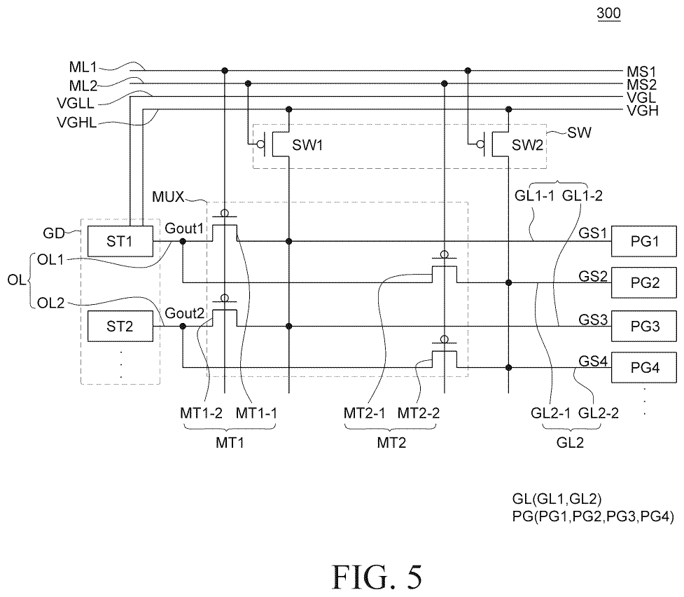

FIG. 5 is a circuit diagram illustrating a gate driver, a MUX unit, and a switching unit of a display device according to still another exemplary embodiment of the present disclosure. Configurations of a display device 300 according to still another exemplary embodiment of the present disclosure of FIG. 5 are the same as those of the display device 100 according to the exemplary embodiment of the present disclosure of FIG. 2 except for a switching unit SW so that a redundant description will be omitted.

A transistor which is described in FIG. 5 may include a first electrode, a second electrode, and a gate electrode. One of the first electrode and the second electrode may be a source electrode and the other one of the first electrode and the second electrode may be a drain electrode. The transistor may be a P-type thin film transistor may be an N-type thin film transistor. In FIG. 5, the transistor is configured as a P-type thin film transistor, but it is not limited thereto. Further, the N-type thin film transistor may be an oxide thin film transistor and the P-type thin film transistor may be a polycrystalline silicon thin film transistor, but they are not limited thereto.

Hereinafter, it is described that the transistor is a P-type thin film transistor as an example. Accordingly, the transistor is applied with a gate low voltage to be turned on.

Referring to FIG. 5, the display device 300 according to still another exemplary embodiment of the present disclosure includes a switching unit SW.

The switching unit SW may be disposed between the gate high voltage line VGHL to which the gate high voltage VGH is supplied and the MUX unit MUX. The switching unit SW may include a first switching transistor SW1 and a second switching transistor SW2.

The first switching transistor SW1 may be connected between the gate high voltage line VGHL and the second electrode of the first MUX transistor MT1. The first switching transistor SW1 may be connected between the gate high voltage line VGHL and the first gate line GL1. For example, the first switching transistor SW1 may include a first electrode connected to the gate high voltage line VGHL, a second electrode connected to a second electrode of the first MUX transistor MT1, and a gate electrode connected to the second MUX signal line ML2 which supplies a second MUX signal MS2. For example, the second electrode of the first switching transistor SW1 may be connected to the second electrodes of the 1-1-th MUX transistor MT1-1 and the 1-2-th MUX transistor MT1-2. For example, the second electrode of the first switching transistor SW1 may be connected to the 1-1-th gate line GL1-1 and the 1-2-th gate line GL1-2.

The second switching transistor SW2 may be connected between the gate high voltage line VGHL and the second electrode of the second MUX transistor MT2. The second switching transistor SW2 may be connected between the gate high voltage line VGHL and the second gate line GL2. For example, the second switching transistor SW2 may include a first electrode connected to the gate high voltage line VGHL, a second electrode connected to a second electrode of the second MUX transistor MT2, and a gate electrode connected to the first MUX signal line ML1 which supplies a first MUX signal MS1. For example, the second electrode of the second switching transistor SW2 may be connected to the second electrodes of the 2-1-th MUX transistor MT2-1 and the 2-2-th MUX transistor MT2-2. For example, the second electrode of the second switching transistor SW2 may be connected to the 2-1-th gate line GL2-1 and the 2-2-th gate line GL2-2.

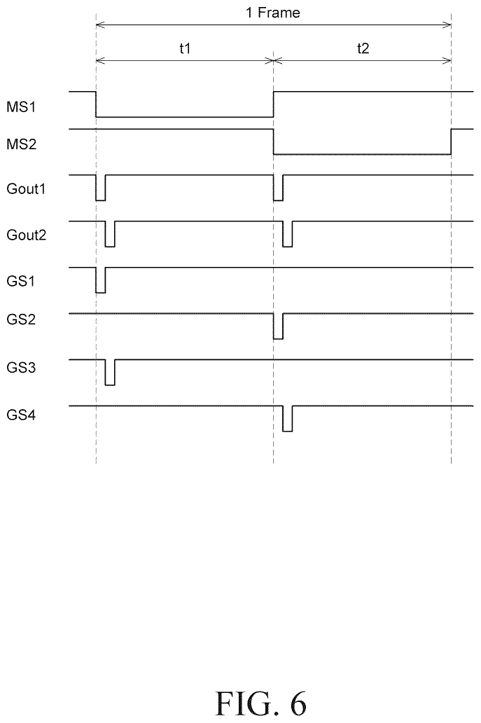

FIG. 6 is a waveform chart illustrating signals which are input and output to and from a gate driver, a MUX unit, and a switching unit of FIG. 5 according to an exemplary embodiment of the present disclosure.

Referring to FIG. 6, one frame may include a first period t1 and a second period t2. The first period t1 and the second period t2 are periods obtained by dividing one frame by a predetermined time. For example, the first period t1 and the second period t2 may be periods obtained by dividing one frame by a ½. In one frame, the gate driver GD may output the plurality of first output signals Gout1 and the plurality of second output signals Gout2. For example, the gate driver GD may output one first output signal Gout1 and one second output signal Gout2 in the first period t1 and output one first signal Gout1 and one second output signal Gout2 in the second period t2.

Referring to FIGS. 5 and 6, in the first period t1, the first MUX signal MS1 is a low voltage and the second MUX signal MS2 is a high voltage. In this case, the 1-1-th MUX transistor MT1-1, the 1-2-th MUX transistor MT1-2, and the second switching transistor SW2 are turned on and the 2-1-th MUX transistor MT2-1, the 2-2-th MUX transistor MT2-2, and the first switching transistor SW1 are turned off.

Therefore, the 1-1-th MUX transistor MT1-1 connects the first output line OL1 and the 1-1-th gate line GL1-1 to output the first output signal Gout1 which is input through the first output line OL1 to the 1-1-th gate line GL1-1 as a first gate signal GS1. By doing this, the first pixel group PG1 may be supplied with the first gate signal GS1 through the 1-1-th gate line GL1-1. Further, the 1-2-th MUX transistor MT1-2 connects the second output line OL2 and the 1-2-th gate line GL1-2 to output the second output signal Gout2 which is input through the second output line OL2 to the 1-2-th gate line GL1-2 as a third gate signal GS3. By doing this, the third pixel group PG3 may be supplied with the third gate signal GS3 through the 1-2-th gate line GL1-2. At this time, the second switching transistor SW2 connects the gate high voltage line VGHL to the 2-1-th gate line GL2-1 and the 2-2-th gate line GL2-2 to output the gate high voltage VGH to the 2-1-th gate line GL2-1 and the 2-2-th gate line GL2-2. By doing this, the second pixel group PG2 may be supplied with the gate high voltage VGH through the 2-1-th gate line GL2-1 and the fourth pixel group PG2 may be supplied with the gate high voltage VGH through the 2-2-th gate line GL2-2.

Referring to FIGS. 5 and 6, in the second period t2, the first MUX signal MS1 is a high voltage and the second MUX signal MS2 is a low voltage. In this case, the 1-1-th MUX transistor MT1-1, the 1-2-th MUX transistor MT1-2, and the second switching transistor SW2 are turned off and the 2-1-th MUX transistor MT2-1, the 2-2-th MUX transistor MT2-2, and the first switching transistor SW1 are turned on.

Therefore, the 2-1-th MUX transistor MT2-1 connects the first output line OL1 and the 2-1-th gate line GL2-1 to output the first output signal Gout1 which is input through the first output line OL1 to the 2-1-th gate line GL2-1 as a second gate signal GS2. By doing this, the second pixel group PG2 may be supplied with the second gate signal GS2 through the 2-1-th gate line GL2-1. Further, the 2-2-th MUX transistor MT2-2 connects the second output line OL2 and the 2-2-th gate line GL2-2 to output the second output signal Gout2 which is input through the second output line OL2 to the 2-2-th gate line GL2-2 as a fourth gate signal GS4. By doing this, the fourth pixel group PG4 may be supplied with the fourth gate signal GS4 through the 2-2-th gate line GL2-2. At this time, the first switching transistor SW1 connects the gate high voltage line VGHL to the 1-1-th gate line GL1-1 and the 1-2-th gate line GL1-2 to output the gate high voltage VGH to the 1-1-th gate line GL1-1 and the 1-2-th gate line GL1-2. By doing this, the first pixel group PG1 may be supplied with the gate high voltage VGH through the 1-1-th gate line GL1-1 and the third pixel group PG3 may be supplied with the gate high voltage VGH through the 1-2-th gate line GL1-2.

In the meantime, in FIG. 6, it is disclosed only that one frame is driven to be divided into the first period t1 and the second period t2. However, when the display device 300 according to still another exemplary embodiment of the present disclosure is driven by changing the resolution to the low resolution, as illustrated in FIG. 4, the gate driver GD may output one first output signal Gout1 and a plurality of second output signals Gout2 during one frame. Therefore, the first output signal Gout1 may be supplied to the first pixel group PG1 as a first gate signal GS1 and the second output signal Gout2 may be supplied to the third pixel group PG3 as a third gate signal GS3. The second pixel group PG2 and the fourth pixel group PG4 may receive the gate high voltage as the second gate signal GS2 and the fourth gate signal GS4, respectively.

The display device 300 according to still another exemplary embodiment of the present disclosure includes a MUX unit MUX disposed between the plurality of output lines OL connected to the gate driver GD and the plurality of gate lines GL connected to the plurality of pixel groups PG. The MUX unit MUX includes a first MUX transistor MT1 which is connected between the output line OL and the first gate line GL1 and operates in response to the first MUX signal MS1 and a second MUX transistor MT2 which is connected between the output line OL and the second gate line GL2 and operates in response to the second MUX signal MS2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 300 according to still another exemplary embodiment of the present disclosure may supply the output signal Gout output from one stage ST to two gate lines GL through the MUX unit MUX as gate signals. Therefore, the number of stages disposed in the non-active area is reduced to ½ to increase the transparency and the degree of freedom of design of the bezel area and the gate signal may be applied to two pixel groups by one stage so that the PPI may be increased without adding a stage.

Further, in the display device 300 according to still another exemplary embodiment of the present disclosure, the first MUX transistor MT1 is connected between the output line OL connected to the gate driver GD and the first gate line GL1 and the second MUX transistor MT2 is connected between the output line OL and the second gate line GL2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 300 according to still another exemplary embodiment of the present disclosure may apply the output signal output from one stage ST to two gate lines through the MUX unit MUX as gate signals so that the size of the gate driver disposed in the bezel area is minimized to minimize the bezel area.

The display device of the related art has a problem in that an abnormal signal is input in a period in which a gate signal should not be input due to external influence, such as a capacitance between the gate line and the other configuration so that the pixel PX erroneously operates.

Therefore, the display device 300 according to still another exemplary embodiment of the present disclosure includes a switching unit SW disposed between the gate high voltage line VGHL and the plurality of gate lines GL. In the switching unit SW, a first switching transistor SW1 which operates in response to the second MUX signal MS2 is connected between the gate high voltage line VGHL and the first gate line GL1 and a second switching transistor SW2 which operates in response to the first MUX signal MS1 is connected between the gate high voltage line VGHL and the second gate line GL2. At this time, the first switching transistor SW1 and the second switching transistor SW2 operate in accordance with the first MUX signal MS1 and the second MUX signal MS2 to connect the gate high voltage line VGHL to one of the first gate line GL1 or the second gate line GL2. Accordingly, the display device 300 according to still another exemplary embodiment of the present disclosure supplies the gate high voltage VGH to the gate line GL to which the gate signal GS is not supplied through the switching unit SW to suppress erroneous operation of the pixel PX included in the pixel group PG. Therefore, an accurate operation is allowed to improve the image quality.

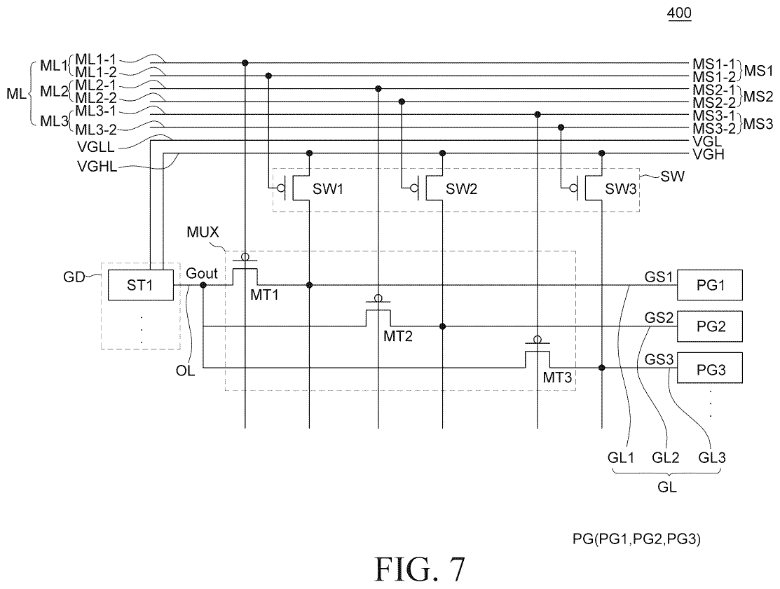

FIG. 7 is a circuit diagram illustrating a gate driver, a MUX unit, and a switching unit of a display device according to still another exemplary embodiment of the present disclosure. In FIG. 7, for the convenience of description, a gate driver GD, a plurality of pixel groups PG, a MUX unit MUX, a switching unit SW, an output line OL, a first gate line GL1, a second gate line GL2, and a third gate line GL3 are illustrated. In the meantime, even though in FIG. 7, for the convenience of description, a plurality of pixel groups PG disposed in three rows are illustrated, the plurality of pixel groups PG disposed in three rows which is described in FIG. 7 may be repeatedly disposed in a column direction.

A transistor which is described in FIG. 7 may include a first electrode, a second electrode, and a gate electrode. One of the first electrode and the second electrode may be a source electrode and the other one of the first electrode and the second electrode may be a drain electrode. The transistor may be a P-type thin film transistor or an N-type thin film transistor. In FIG. 7, the transistor is configured as a P-type thin film transistor, but it is not limited thereto. Further, the N-type thin film transistor may be an oxide thin film transistor and the P-type thin film transistor may be a polycrystalline silicon thin film transistor, but they are not limited thereto.

Hereinafter, it is described that the transistor is a P-type thin film transistor as an example. Accordingly, the transistor is applied with a gate low voltage to be turned on.

Referring to FIG. 7, a plurality of pixel groups PG are disposed in the active area AA of the display device 400 according to still another exemplary embodiment of the present disclosure. The plurality of pixel groups PG may be disposed in the order of a first pixel group PG1, a second pixel group PG2, and a third pixel group PG3 from the first row. For example, the first pixel group PG1 may be a set of pixels PX disposed in a 3n-2-th (n is an integer) row, the second pixel group PG2 may be a set of pixels PX disposed in a 3n-1-th row, and the third pixel group PG3 may be a set of pixels PX disposed in a 3n-th row.

The plurality of gate lines GL may include a first gate line GL1, a second gate line GL2, and a third gate line GL3. For example, the first gate line GL1 may be connected to the first pixel group PG1, the second gate line GL2 may be connected to the second pixel group PG2, and the third gate line GL3 may be connected to the third pixel group PG3. For example, the first gate line GL1 supplies a first gate signal GS1 to the first pixel group PG1, the second gate line GL2 supplies a second gate signal GS2 to the second pixel group PG2, and the third gate line GL3 supplies a third gate signal GS3 to the third pixel group PG3.

The gate driver GD may be implemented as a gate shift register which is configured by a plurality of stages ST. The plurality of stages may generate and output an output signal. The plurality of stages may receive an external start signal, a plurality of clock signals, a gate high voltage VGH which is a gate off voltage, and a gate low voltage VGL which is a gate on voltage to output the output signal. However, the present disclosure is not limited thereto and in the case of the N-type transistor, the gate high voltage VGH may be a gate on voltage and the gate low voltage VGL may be a gate off voltage. For example, referring to FIG. 7, the gate driver GD may be connected to a gate high voltage line VGHL which is supplied with a gate high voltage VGH and a gate low voltage line VGLL which is supplied with a gate low voltage VGL.

The plurality of stages are sequentially activated according to the start signal to output the output signal. The plurality of stages may be a plurality of scan driving stages and a plurality of emission driving stages.

However, in FIG. 7, for the convenience of description, the first stage ST1 of the gate driver GD is illustrated, but the stages may be repeatedly disposed in a column direction.

An operation of the first stage ST1 is activated according to an external start signal and operations of the second stage to the lowest stage are activated according to an output signal output from a previous stage. The output signal of the previous stage is an internal start signal and may be a carry signal. Here, the “previous stage” may refer to a stage which is located above a reference stage to generate an output signal which has a phase earlier than an output signal output from the reference stage.

The first stage ST1 may be connected to the output line OL which outputs the output signal Gout.

The MUX unit MUX may be connected between the gate driver GD and the plurality of pixel groups PG. Specifically, the MUX unit MUX may be connected between the plurality of gate lines GL and the output line OL. The MUX unit MUX may receive an output signal Gout output from the first stage ST1 and output a gate signal to the plurality of gate lines GL in accordance with a first MUX signal MS1, a second MUX signal MS2, and a third MUX signal MS3 which are applied through the plurality of MUX signal lines ML.

The plurality of MUX signal lines ML may include a first MUX signal line ML1 which supplies the first MUX signal MS1, a second MUX signal line ML2 which supplies the second MUX signal MS2, and a third MUX signal line ML3 which supplies the third MUX signal MS3.

For example, the first MUX signal line ML1 may include a 1-1-th MUX signal line ML1-1 which supplies a 1-1-th MUX signal MS1-1 and a 1-2-th MUX signal line ML1-2 which supplies a 1-2-th MUX signal MS1-2. The second MUX signal line ML2 may include a 2-1-th MUX signal line ML2-1 which supplies a 2-1-th MUX signal MS2-1 and a 2-2-th MUX signal line ML2-2 which supplies a 2-2-th MUX signal MS2-2. The third MUX signal line ML3 may include a 3-1-th MUX signal line ML3-1 which supplies a 3-1-th MUX signal MS3-1 and a 3-2-th MUX signal line ML3-2 which supplies a 3-2-th MUX signal MS3-2.

The MUX unit MUX may include a first MUX transistor MT1, a second MUX transistor MT2, and a third MUX transistor MT3.

The first MUX transistor MT1 may be connected between the output line OL and the first gate line GL1. For example, the first MUX transistor MT1 may include a first electrode connected to the output line OL, a second electrode connected to the first gate line GL1, and a gate line connected to the 1-1-th MUX signal line ML1-1.

The second MUX transistor MT2 may be connected between the output line OL and the second gate line GL2. For example, the second MUX transistor MT2 may include a first electrode connected to the output line OL, a second electrode connected to a second gate line GL2, and a gate electrode connected to a 2-1-th MUX signal line ML2-1 which supplies a 2-1-th MUX signal MS2-1.

The third MUX transistor MT3 may be connected between the output line OL and the third gate line GL3. For example, the third MUX transistor MT3 may include a first electrode connected to the output line OL, a second electrode connected to a third gate line GL3, and a gate electrode connected to a 3-1-th MUX signal line ML3-1 which supplies a 3-1-th MUX signal MS3-1.

The switching unit SW may be disposed between the gate high voltage line VGHL to which the gate high voltage VGH is supplied and the MUX unit MUX. The switching unit SW may include a first switching transistor SW1, a second switching transistor SW2, and a third switching transistor SW3.

The first switching transistor SW1 may be connected between the gate high voltage line VGHL and the second electrode of the first MUX transistor MT1. The first switching transistor SW1 may be connected between the gate high voltage line VGHL and the first gate line GL1. For example, the first switching transistor SW1 may include a first electrode connected to the gate high voltage line VGHL, a second electrode connected to a second electrode of the first MUX transistor MT1, and a gate electrode connected to the 1-2-th MUX signal line ML1-2 which supplies a 1-2-th MUX signal MS1-2. For example, the second electrode of the first switching transistor SW1 may be connected to the second electrode of the first MUX transistor MT1. For example, the second electrode of the first switching transistor SW1 may be connected to the first gate line GL1.

The second switching transistor SW2 may be connected between the gate high voltage line VGHL and the second electrode of the second MUX transistor MT2. The second switching transistor SW2 may be connected between the gate high voltage line VGHL and the second gate line GL2. For example, the second switching transistor SW2 may include a first electrode connected to the gate high voltage line VGHL, a second electrode connected to a second electrode of the second MUX transistor MT2, and a gate electrode connected to the 2-2-th MUX signal line ML2-2 which supplies a 2-2-th MUX signal MS2-2. For example, the second electrode of the second switching transistor SW2 may be connected to the second electrode of the second MUX transistor MT2. For example, the second electrode of the second switching transistor SW2 may be connected to the second gate line GL2.

The third switching transistor SW3 may be connected between the gate high voltage line VGHL and the second electrode of the third MUX transistor MT3. The third switching transistor SW3 may be connected between the gate high voltage line VGHL and the third gate line GL3. For example, the third switching transistor SW3 may include a first electrode connected to the gate high voltage line VGHL, a second electrode connected to a second electrode of the third MUX transistor MT3, and a gate electrode connected to the 3-2-th MUX signal line ML3-2 which supplies a 3-2-th MUX signal MS3-2. For example, the second electrode of the third switching transistor SW3 may be connected to the second electrode of the third MUX transistor MT3. For example, the second electrode of the third switching transistor SW3 may be connected to the third gate line GL3.

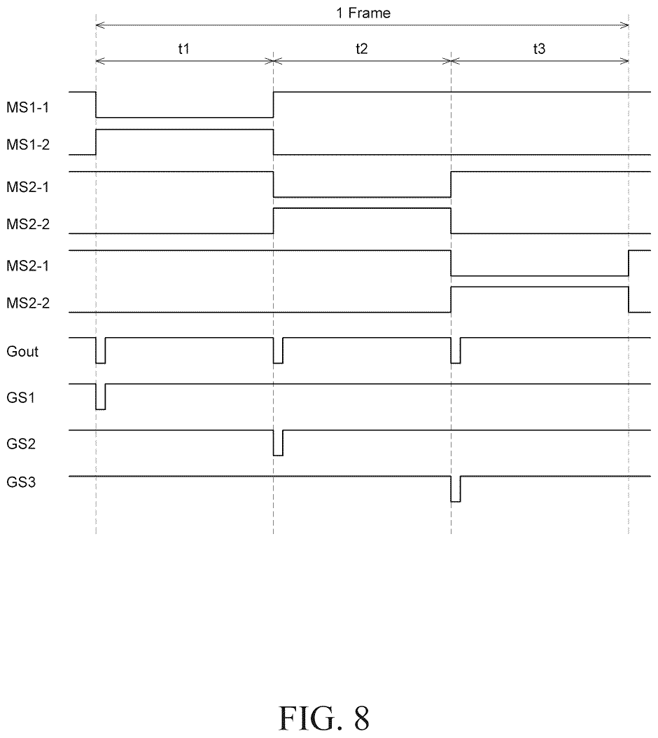

FIG. 8 is a waveform chart illustrating signals which are input and output to and from a gate driver, a MUX unit, and a switching unit of FIG. 7.

Referring to FIG. 8, one frame may include a first period t1, a second period t2, and a third period t3. The first period t1, the second period t2, and the third period t3 are periods obtained by dividing one frame by a predetermined time. For example, the first period t1, the second period t2, and the third period t3 may be periods obtained by dividing one frame by ⅓. In one frame, the gate driver GD may output three output signals Gout. For example, the gate driver GD may output one output signal Gout in the first period t1, output one output signal Gout in the second period t2, and output one output signal Gout in the third period t3.

Referring to FIGS. 7 and 8, in the first period t1, the 1-1-th MUX signal MS1-1, the 2-2-th MUX signal MS2-2, and the 3-2-th MUX signal MS3-2 are low voltages and the 1-2-th MUX signal MS1-2, the 2-1-th MUX signal MS2-1, and the 3-1-th MUX signal MS3-1 are high voltages. In this case, the first MUX transistor MT1, the second switching transistor SW2, and the third switching transistor SW3 are turned on and the second MUX transistor MT2, the third MUX transistor MT3, and the first switching transistor SW1 are turned off.

Therefore, the first MUX transistor MT1 connects the output line OL and the first gate line GL1 to output the output signal Gout output through the output line OL to the first gate line GL1 as a first gate signal GS1. By doing this, the first pixel group PG1 may be supplied with the first gate signal GS1 through the first gate line GL1. Further, the second switching transistor SW2 connects the gate high voltage line VGHL to the second gate line GL2 to output the gate high voltage VGH to the second gate line GL2. The third switching transistor SW3 connects the gate high voltage line VGHL to the third gate line GL3 to output the gate high voltage VGH to the third gate line GL3. By doing this, the second pixel group PG2 and the third pixel group PG3 may be supplied with the gate high voltage VGH through the second gate line GL2 and the third gate line GL3.

In the second period t2, the 1-2-th MUX signal MS1-2, the 2-1-th MUX signal MS2-1, and the 3-2-th MUX signal MS3-2 are low voltages and the 1-1-th MUX signal MS1-1, the 2-2-th MUX signal MS2-2, and the 3-1-th MUX signal MS3-1 are high voltages. In this case, the second MUX transistor MT2, the first switching transistor SW1, and the third switching transistor SW3 are turned on and the first MUX transistor MT1, the third MUX transistor MT3, and the second switching transistor SW2 are turned off.

Therefore, the second MUX transistor MT2 connects the output line OL and the second gate line GL2 to output the output signal Gout output through the output line OL to the second gate line GL2 as a second gate signal GS2. By doing this, the second pixel group PG2 may be supplied with the second gate signal GS2 through the second gate line GL2. Further, the first switching transistor SW1 connects the gate high voltage line VGHL to the first gate line GL1 to output the gate high voltage VGH to the first gate line GL1. The third switching transistor SW3 connects the gate high voltage line VGHL to the third gate line GL3 to output the gate high voltage VGH to the third gate line GL3. By doing this, the first pixel group PG1 and the third pixel group PG3 may be supplied with the gate high voltage VGH through the first gate line GL1 and the third gate line GL3.

In the third period t3, the 1-2-th MUX signal MS1-2, the 2-2-th MUX signal MS2-2, and the 3-1-th MUX signal MS3-1 are low voltages and the 1-1-th MUX signal MS1-1, the 2-1-th MUX signal MS2-1, and the 3-2-th MUX signal MS3-2 are high voltages. In this case, the third MUX transistor MT3, the first switching transistor SW1, and the second switching transistor SW2 are turned on and the first MUX transistor MT1, the second MUX transistor MT2, and the third switching transistor SW3 are turned off.

Therefore, the third MUX transistor MT3 connects the output line OL and the third gate line GL3 to output the output signal Gout output through the output line OL to the third gate line GL3 as a third gate signal GS3. By doing this, the third pixel group PG3 may be supplied with the third gate signal GS3 through the third gate line GL3. Further, the first switching transistor SW1 connects the gate high voltage line VGHL to the first gate line GL1 to output the gate high voltage VGH to the first gate line GL1. The second switching transistor SW2 connects the gate high voltage line VGHL to the second gate line GL2 to output the gate high voltage VGH to the second gate line GL2. By doing this, the first pixel group PG1 and the second pixel group PG2 may be supplied with the gate high voltage VGH through the first gate line GL1 and the second gate line GL2.

The display device 400 according to still another exemplary embodiment of the present disclosure includes a MUX unit MUX disposed between the output line OL connected to the gate driver GD and the plurality of gate lines GL connected to the plurality of pixel groups PG. The MUX unit MUX includes a first MUX transistor MT1, a second MUX transistor MT2, and a third MUX transistor MT3. The first MUX transistor is connected between the output line OL and the first gate line GL1 and operates in response to the first MUX signal MS1. The second MUX transistor MT2 is connected between the output line OL and the second gate line GL2 and operates in response to the second MUX signal MS2. The third MUX transistor MT3 is connected between the output line OL and the third gate line GL3 and operates in response to the third MUX signal MS3. The first MUX transistor MT1, the second MUX transistor MT2, and the third MUX transistor MT3 operate in accordance with the first MUX signal MS1, the second MUX signal MS2, and the third MUX signal MS3 to connect the output line OL to one of the first gate line GL1, the second gate line GL2, and the third gate line GL3. Accordingly, the display device 400 according to still another exemplary embodiment of the present disclosure may supply the output signal output from one stage ST to three gate lines through the MUX unit MUX as gate signals. Therefore, the number of stages disposed in the non-active area is reduced to ⅓ to increase the transparency and the degree of freedom of design of the bezel area and the gate signal may be applied to three pixel groups by one stage so that the PPI may be increased without adding a stage.

Further, in the display device 400 according to still another exemplary embodiment of the present disclosure, the first MUX transistor MT1 is connected between the output line OL connected to the gate driver GD and the first gate line GL1 and the second MUX transistor MT2 is connected between the output line OL and the second gate line GL2. The third MUX transistor MT3 is connected between the output line OL and the third gate line GL3. Therefore, the first MUX transistor MT1, the second MUX transistor MT2, and the third MUX transistor MT3 operate in accordance with the first MUX signal MS1, the second MUX signal MS2, and the third MUX signal MS3 to connect the output line OL to one of the first gate line GL1, the second gate line GL2, and the third gate line GL3. Accordingly, the display device 400 according to still another exemplary embodiment of the present disclosure may apply the output signal output from one stage ST to three gate lines through the MUX unit MUX as gate signals so that the size of the gate driver disposed in the bezel area is minimized to minimize the bezel area.

The display device 400 according to still another exemplary embodiment of the present disclosure includes a switching unit SW disposed between the gate high voltage line VGHL and gate lines GL1, GL2, and GL3, respectively. In the switching unit SW, a plurality of switching transistors SW1, SW2, and SW3 which operate in response to the MUX signals MS1, MS2, and MS3 are connected between the gate high voltage line VGHL and gate lines GL1, GL2, and GL3, respectively. At this time, the plurality of switching transistors SW1, SW2, and SW3 operate in accordance with the MUX signals MS1, MS2, and MS3 to connect the gate high voltage line VGHL to one of the gate lines GL1, GL2, and GL3 to apply the gate high voltage VGH. Accordingly, the display device 400 according to still another exemplary embodiment of the present disclosure supplies the gate high voltage VGH to the gate line GL to which the gate signal GS is not supplied through the switching unit SW to suppress erroneous operation of the pixel PX included in the pixel group PG. Therefore, an accurate operation is allowed to improve the image quality.

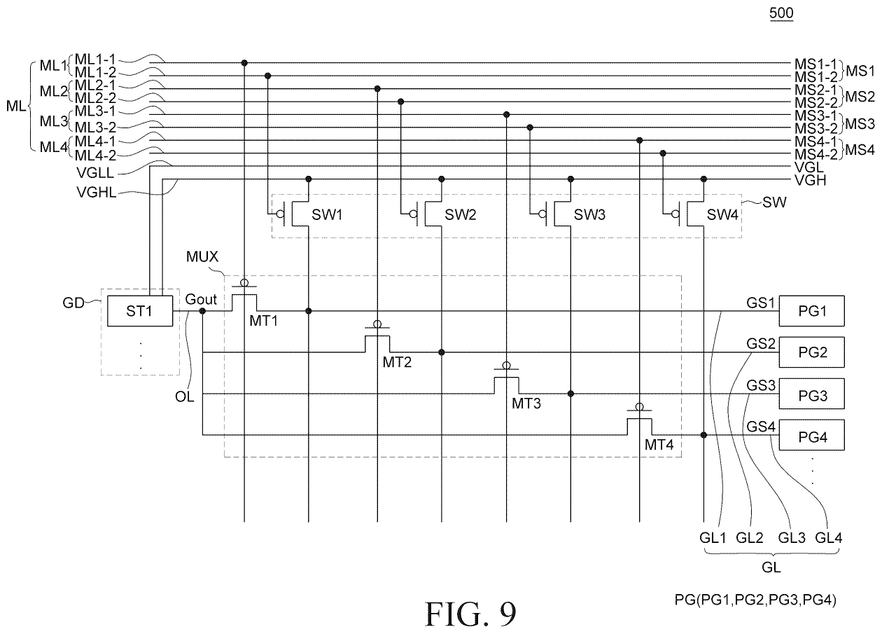

FIG. 9 is a circuit diagram illustrating a gate driver, a MUX unit, and a switching unit of a display device according to still another exemplary embodiment of the present disclosure. In FIG. 9, for the convenience of description, a gate driver GD, a plurality of pixel groups PG, a MUX unit MUX, a switching unit SW, an output line OL, a first gate line GL1, a second gate line GL2, a third gate line GL3, and a fourth gate line GL4 are illustrated. In the meantime, even though in FIG. 9, for the convenience of description, a plurality of pixel groups PG disposed in four rows are illustrated, the plurality of pixel groups PG disposed in four rows which is described in FIG. 9 may be repeatedly disposed in a column direction.

A transistor which is described in FIG. 9 may include a first electrode, a second electrode, and a gate electrode. One of the first electrode and the second electrode may be a source electrode and the other one of the first electrode and the second electrode may be a drain electrode. The transistor may be a P-type thin film transistor or an N-type thin film transistor. In FIG. 9, the transistor is configured as a P-type thin film transistor, but it is not limited thereto. Further, the N-type thin film transistor may be an oxide thin film transistor and the P-type thin film transistor may be a polycrystalline silicon thin film transistor, but they are not limited thereto.

Hereinafter, it is described that the transistor is a P-type thin film transistor as an example. Accordingly, the transistor is applied with a gate low voltage to be turned on.

Referring to FIG. 9, a plurality of pixel groups PG is disposed in the active area AA of the display device 500 according to still another exemplary embodiment of the present disclosure. The plurality of pixel groups PG may be disposed in the order of a first pixel group PG1, a second pixel group PG2, a third pixel group PG3, and a fourth pixel group PG4 from the first row. For example, the first pixel group PG1 may be a set of pixels PX disposed in a 4n-3-th row (n is an integer), the second pixel group PG2 may be a set of pixels PX disposed in a 4n-2-th row, the third pixel group PG3 may be a set of pixels PX disposed in a 4n-1-th row, and the fourth pixel group PG4 may be a set of pixels PX disposed in a 4n-th row.

The plurality of gate lines GL may include a first gate line GL1, a second gate line GL2, a third gate line GL3, and a fourth gate line GL4. For example, the first gate line GL1 may be connected to the first pixel group PG1, the second gate line GL2 may be connected to the second pixel group PG2, the third gate line GL3 may be connected to the third pixel group PG3, and the fourth gate line GL4 may be connected to the fourth pixel group PG4. For example, the first gate line GL1 may supply a first gate signal GS1 to the first pixel group PG1, the second gate line GL2 may supply a second gate signal GS2 to the second pixel group PG2, the third gate line GL3 may supply a third gate signal GS3 to the third pixel group PG3, the fourth gate line GL4 may supply a fourth gate signal GS4 to the fourth pixel group PG4.

The MUX unit MUX may be connected between the gate driver GD and the plurality of pixel groups PG. Specifically, the MUX unit MUX may be connected between the plurality of gate lines GL and the output line OL. The MUX unit MUX may receive an output signal Gout output from the first stage ST1 and output a gate signal to the plurality of gate lines GL in accordance with a first MUX signal MS1, a second MUX signal MS2, a third MUX signal MS3, and a fourth MUX signal MS4 which are applied through the plurality of MUX signal lines ML.

The plurality of MUX signal lines ML may include a first MUX signal line ML1 which supplies the first MUX signal MS1, a second MUX signal line ML2 which supplies the second MUX signal MS2, a third MUX signal line ML3 which supplies the third MUX signal MS3, and a fourth MUX signal line ML4 which supplies the fourth MUX signal MS4.

For example, the first MUX signal line ML1 may include a 1-1-th MUX signal line ML1-1 which supplies a 1-1-th MUX signal MS1-1 and a 1-2-th MUX signal line ML1-2 which supplies a 1-2-th MUX signal MS1-2. The second MUX signal line ML2 may include a 2-1-th MUX signal line ML2-1 which supplies a 2-1-th MUX signal MS2-1 and a 2-2-th MUX signal line ML2-2 which supplies a 2-2-th MUX signal MS2-2. The third MUX signal line ML3 may include a 3-1-th MUX signal line ML3-1 which supplies a 3-1-th MUX signal MS3-1 and a 3-2-th MUX signal line ML3-2 which supplies a 3-2-th MUX signal MS3-2. The fourth MUX signal line ML4 may include a 4-1-th MUX signal line ML4-1 which supplies a 4-1-th MUX signal MS4-1 and a 4-2-th MUX signal line ML4-2 which supplies a 4-2-th MUX signal MS4-2.

The MUX unit MUX may include a first MUX transistor MT1, a second MUX transistor MT2, a third MUX transistor MT3, and a fourth MUX transistor MT4.

The first MUX transistor MT1 may be connected between the output line OL and the first gate line GL1. For example, the first MUX transistor MT1 may include a first electrode connected to the output line OL, a second electrode connected to the first gate line GL1, and a gate line connected to the 1-1-th MUX signal line ML1-1.

The second MUX transistor MT2 may be connected between the output line OL and the second gate line GL2. For example, the second MUX transistor MT2 may include a first electrode connected to the first output line OL, a second electrode connected to a second gate line GL2, and a gate electrode connected to a 2-1-th MUX signal line ML2-1 which supplies a 2-1-th MUX signal MS2-1.

The third MUX transistor MT3 may be connected between the output line OL and the third gate line GL3. For example, the third MUX transistor MT3 may include a first electrode connected to the output line OL, a second electrode connected to a third gate line GL3, and a gate electrode connected to a 3-1-th MUX signal line ML3-1 which supplies a 3-1-th MUX signal MS3-1.

The fourth MUX transistor MT4 may be connected between the output line OL and the fourth gate line GL4. For example, the fourth MUX transistor MT4 may include a first electrode connected to the output line OL, a second electrode connected to a fourth gate line GL4, and a gate electrode connected to a 4-1-th MUX signal line ML4-1 which supplies a 4-1-th MUX signal MS4-1.

The switching unit SW may be disposed between the gate high voltage line VGHL to which the gate high voltage VGH is supplied and the MUX unit MUX. The switching unit SW may include a first switching transistor SW1, a second switching transistor SW2, a third switching transistor SW3, and a fourth switching transistor SW4.

The first switching transistor SW1 may be connected between the gate high voltage line VGHL and the second electrode of the first MUX transistor MT1. The first switching transistor SW1 may be connected between the gate high voltage line VGHL and the first gate line GL1. For example, the first switching transistor SW1 may include a first electrode connected to the gate high voltage line VGHL, a second electrode connected to a second electrode of the first MUX transistor MT1, and a gate electrode connected to the 1-2-th MUX signal line ML1-2 which supplies a 1-2-th MUX signal MS1-2. For example, the second electrode of the first switching transistor SW1 may be connected to the second electrode of the first MUX transistor MT1. For example, the second electrode of the first switching transistor SW1 may be connected to the first gate line GL1.

The second switching transistor SW2 may be connected between the gate high voltage line VGHL and the second electrode of the second MUX transistor MT2. The second switching transistor SW2 may be connected between the gate high voltage line VGHL and the second gate line GL2. For example, the second switching transistor SW2 may include a first electrode connected to the gate high voltage line VGHL, a second electrode connected to a second electrode of the second MUX transistor MT2, and a gate electrode connected to the 2-2-th MUX signal line ML2-2 which supplies a 2-2-th MUX signal MS2-2. For example, the second electrode of the second switching transistor SW2 may be connected to the second electrode of the second MUX transistor MT2. For example, the second electrode of the second switching transistor SW2 may be connected to the second gate line GL2.

The third switching transistor SW3 may be connected between the gate high voltage line VGHL and the second electrode of the third MUX transistor MT3. The third switching transistor SW3 may be connected between the gate high voltage line VGHL and the third gate line GL3. For example, the third switching transistor SW3 may include a first electrode connected to the gate high voltage line VGHL, a second electrode connected to a second electrode of the third MUX transistor MT3, and a gate electrode connected to the 3-2-th MUX signal line ML3-2 which supplies a 3-2-th MUX signal MS3-2. For example, the second electrode of the third switching transistor SW3 may be connected to the second electrode of the third MUX transistor MT3. For example, the second electrode of the third switching transistor SW3 may be connected to the third gate line GL3.

The fourth switching transistor SW4 may be connected between the gate high voltage line VGHL and the second electrode of the fourth MUX transistor MT4. The fourth switching transistor SW4 may be connected between the gate high voltage line VGHL and the fourth gate line GL4. For example, the fourth switching transistor SW4 may include a first electrode connected to the gate high voltage line VGHL, a second electrode connected to a second electrode of the fourth MUX transistor MT4, and a gate electrode connected to the 4-2-th MUX signal line ML4-2 which supplies a 4-2-th MUX signal MS4-2. For example, the second electrode of the fourth switching transistor SW4 may be connected to the second electrode of the fourth MUX transistor MT4. For example, the second electrode of the fourth switching transistor SW4 may be connected to the fourth gate line GL4.

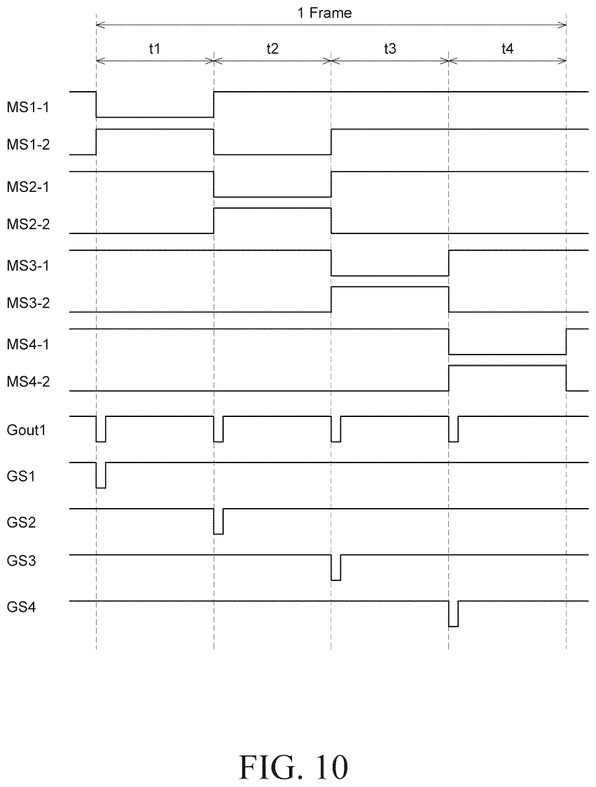

FIG. 10 is a waveform chart illustrating signals which are input and output to and from a gate driver, a MUX unit, and a switching unit of FIG. 9.

Referring to FIG. 10, one frame may include a first period t1, a second period t2, a third period t3, and a fourth period t4. The first period t1, the second period t2, the third period t3, and the fourth period t4 are periods obtained by dividing one frame by a predetermined time. For example, the first period t1, the second period t2, the third period t3, and the fourth period t4 may be periods obtained by dividing one frame by ¼. In one frame, the gate driver GD may output four output signals Gout. For example, the gate driver GD may output one output signal Gout in the first period t1, output one output signal Gout in the second period t2, output one output signal Gout in the third period t3, and output one output signal Gout in the fourth period t4.

Referring to FIGS. 9 and 10, in the first period t1, the 1-1-th MUX signal MS1-1, the 2-2-th MUX signal MS2-2, the 3-2-th MUX signal MS3-2, and the 4-2-th MUX signal MS4-2 are low voltages and the 1-2-th MUX signal MS1-2, the 2-1-th MUX signal MS2-1, the 3-1-th MUX signal MS3-1. and the 4-1-th MUX signal MS4-1 are high voltages. In this case, the first MUX transistor MT1, the second switching transistor SW2, the third switching transistor SW3, and the fourth switching transistor SW4 are turned on and the second MUX transistor MT2, the third MUX transistor MT3, the fourth MUX transistor MT4, and the first switching transistor SW1 are turned off.

Therefore, the first MUX transistor MT1 connects the output line OL and the first gate line GL1 to output the output signal Gout output through the output line OL to the first gate line GL1 as a first gate signal GS1. By doing this, the first pixel group PG1 may be supplied with the first gate signal GS1 through the first gate line GL1. Further, the second switching transistor SW2 connects the gate high voltage line VGHL to the second gate line GL2 to output the gate high voltage VGH to the second gate line GL2. The third switching transistor SW3 connects the gate high voltage line VGHL to the third gate line GL3 to output the gate high voltage VGH to the third gate line GL3. The fourth switching transistor SW4 connects the gate high voltage line VGHL to the fourth gate line GL4 to output the gate high voltage VGH to the fourth gate line GL4. By doing this, the second pixel group PG2, the third pixel group PG3, and the fourth pixel group PG4 may be supplied with the gate high voltage VGH through the second gate line GL2, the third gate line GL3, and the fourth gate line GL4.

In the second period t2, the 1-2-th MUX signal MS1-2, the 2-1-th MUX signal MS2-1, the 3-2-th MUX signal MS3-2, and the 4-2-th MUX signal MS4-2 are low voltages and the 1-1-th MUX signal MS1-1, the 2-2-th MUX signal MS2-2, the 3-1-th MUX signal MS3-1, and the 4-1-th MUX signal MS4-1 are high voltages. In this case, the second MUX transistor MT2, the first switching transistor SW1, the third switching transistor SW3, and the fourth switching transistor SW4 are turned on and the first MUX transistor MT1, the third MUX transistor MT3, the fourth MUX transistor MT4, and the second switching transistor SW2 are turned off.

Therefore, the second MUX transistor MT2 connects the output line OL and the second gate line GL2 to output the output signal Gout output through the output line OL to the second gate line GL2 as a second gate signal GS2. By doing this, the second pixel group PG2 may be supplied with the second gate signal GS2 through the second gate line GL2. Further, the first switching transistor SW1 connects the gate high voltage line VGHL to the first gate line GL1 to output the gate high voltage VGH to the first gate line GL1. The third switching transistor SW3 connects the gate high voltage line VGHL to the third gate line GL3 to output the gate high voltage VGH to the third gate line GL3. The fourth switching transistor SW4 connects the gate high voltage line VGHL to the fourth gate line GL4 to output the gate high voltage VGH to the fourth gate line GL4. By doing this, the first pixel group PG1, the third pixel group PG3, and the fourth pixel group PG4 may be supplied with the gate high voltage VGH through the first gate line GL1, the third gate line GL3, and the fourth gate line GL4.

In the third period t3, the 1-2-th MUX signal MS1-2, the 2-2-th MUX signal MS2-2, the 3-1-th MUX signal MS3-1, and the 4-2-th MUX signal MS4-2 are low voltages and the 1-1-th MUX signal MS1-1, the 2-1-th MUX signal MS2-1, the 3-2-th MUX signal MS3-2, and the 4-1-th MUX signal MS4-1 are high voltages. In this case, the third MUX transistor MT3, the first switching transistor SW1, the second switching transistor SW2, and the fourth switching transistor SW4 are turned on and the first MUX transistor MT1, the second MUX transistor MT2, the fourth MUX transistor MT4, and the third switching transistor SW3 are turned off.

Therefore, the third MUX transistor MT3 connects the output line OL and the third gate line GL3 to output the output signal Gout output through the output line OL to the third gate line GL3 as a third gate signal GS3. By doing this, the third pixel group PG3 may be supplied with the third gate signal GS3 through the third gate line GL3. Further, the first switching transistor SW1 connects the gate high voltage line VGHL to the first gate line GL1 to output the gate high voltage VGH to the first gate line GL1. The second switching transistor SW2 connects the gate high voltage line VGHL to the second gate line GL2 to output the gate high voltage VGH to the second gate line GL2. The fourth switching transistor SW4 connects the gate high voltage line VGHL to the fourth gate line GL4 to output the gate high voltage VGH to the fourth gate line GL4. By doing this, the first pixel group PG1, the second pixel group PG2, and the fourth pixel group PG4 may be supplied with the gate high voltage VGH through the first gate line GL1, the second gate line GL2, and the fourth gate line GL4.

In the fourth period t4, the 2-2-th MUX signal MS2-2, the 3-2-th MUX signal MS3-2, and the 4-1-th MUX signal MS4-1 are low voltages and the 1-1-th MUX signal MS1-1, the 1-2-th MUX signal MS1-2, the 2-1-th MUX signal MS2-1, the 3-1-th MUX signal MS3-1, and the 4-2-th MUX signal MS4-2 are high voltages. In this case, the fourth MUX transistor MT4, the first switching transistor SW1, the second switching transistor SW2, and the third switching transistor SW3 are turned on and the first MUX transistor MT1, the second MUX transistor MT2, the third MUX transistor MT3, and the fourth switching transistor SW4 are turned off.

Therefore, the fourth MUX transistor MT4 connects the output line OL and the fourth gate line GL4 to output the output signal Gout output through the output line OL to the fourth gate line GL4 as a fourth gate signal GS4. By doing this, the fourth pixel group PG4 may be supplied with the fourth gate signal GS4 through the fourth gate line GL4. Further, the first switching transistor SW1 connects the gate high voltage line VGHL to the first gate line GL1 to output the gate high voltage VGH to the first gate line GL1. The second switching transistor SW2 connects the gate high voltage line VGHL to the second gate line GL2 to output the gate high voltage VGH to the second gate line GL2. The third switching transistor SW3 connects the gate high voltage line VGHL to the third gate line GL3 to output the gate high voltage VGH to the third gate line GL3. By doing this, the first pixel group PG1, the second pixel group PG2, and the third pixel group PG3 may be supplied with the gate high voltage VGH through the first gate line GL1, the second gate line GL2, and the third gate line GL3.

The display device 500 according to still another exemplary embodiment of the present disclosure includes a MUX unit MUX disposed between the output line OL connected to the gate driver GD and the plurality of gate lines GL connected to the plurality of pixel groups PG. The MUX unit MUX includes a first MUX transistor MT1, a second MUX transistor MT2, a third MUX transistor MT3, and a fourth MUX transistor MT4. The first MUX transistor is connected between the output line OL and the first gate line GL1 and operates in response to the first MUX signal MS1. The second MUX transistor MT2 is connected between the output line OL and the second gate line GL2 and operates in response to the second MUX signal MS2. The third MUX transistor MT3 is connected between the output line OL and the third gate line GL3 and operates in response to the third MUX signal MS3. The fourth MUX transistor MT4 is connected between the output line OL and the fourth gate line GL4 and operates in response to the fourth MUX signal MS4. Therefore, the first MUX transistor MT1, the second MUX transistor MT2, the third MUX transistor MT3, and the fourth MUX transistor MT4 operate in accordance with the first MUX signal MS1, the second MUX signal MS2, the third MUX signal MS3, and the fourth MUX signal MS4 to connect the output line OL to one of the first gate line GL1, the second gate line GL2, the third gate line GL3, and the fourth gate line GL4. Accordingly, the display device 500 according to still another exemplary embodiment of the present disclosure may supply the output signal output from one stage ST to four gate lines through the MUX unit MUX as gate signals. Therefore, the number of stages disposed in the non-active area is reduced to ¼ to increase the transparency and the degree of freedom of design of the bezel area and the gate signal may be applied to four pixel groups by one stage so that the PPI may be increased without adding a stage.

Further, in the display device 500 according to still another exemplary embodiment of the present disclosure, the first MUX transistor MT1 is connected between the output line OL connected to the gate driver GD and the first gate line GL1 and the second MUX transistor MT2 is connected between the output line OL and the second gate line GL2. The third MUX transistor MT3 is connected between the output line OL and the third gate line GL3 and the fourth MUX transistor MT4 is connected between the output line OL and the fourth gate line GL4. Therefore, the first MUX transistor MT1, the second MUX transistor MT2, the third MUX transistor MT3, and the fourth MUX transistor MT4 operate in accordance with the first MUX signal MS1, the second MUX signal MS2, the third MUX signal MS3, and the fourth MUX signal MS4 to connect the output line OL to one of the first gate line GL1, the second gate line GL2, the third gate line GL3, and the fourth gate line GL4. Accordingly, the display device 500 according to still another exemplary embodiment of the present disclosure may apply the output signal output from one stage ST to four gate lines through the MUX unit MUX as gate signals so that the size of the gate driver disposed in the bezel area is minimized to minimize the bezel area.

The display device 500 according to still another exemplary embodiment of the present disclosure includes a switching unit SW disposed between the gate high voltage line VGHL and gate lines GL1, GL2, GL3, and GL4, respectively. In the switching unit SW, a plurality of switching transistors SW1, SW2, SW3, and SW4 which operate in response to the MUX signals MS1, MS2, MS3, and MS4 are connected between the gate high voltage line VGHL and gate lines GL1, GL2, GL3, and GL4, respectively. At this time, the plurality of switching transistors SW1, SW2, SW3, and SW4 operate in accordance with the MUX signals MS1, MS2, MS3, and MS4 to connect the gate high voltage line VGHL to one of the gate lines GL1, GL2, GL3, and GL4 to apply the gate high voltage VGH. Accordingly, the display device 500 according to still another exemplary embodiment of the present disclosure supplies the gate high voltage VGH to the gate line GL to which the gate signal GS is not supplied through the switching unit SW to suppress erroneous operation of the pixel PX included in the pixel group PG. Therefore, an accurate operation is allowed to improve the image quality.

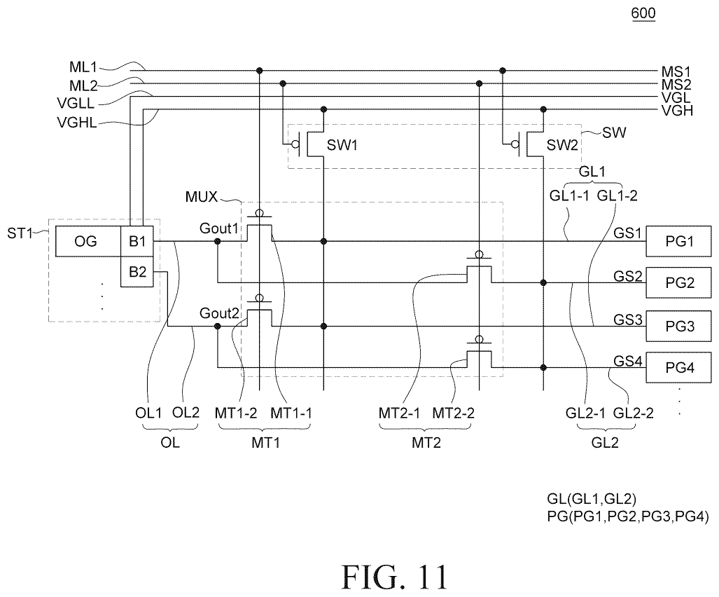

FIG. 11 is a circuit diagram illustrating a gate driver, a MUX unit, and a switching unit of a display device according to still another exemplary embodiment of the present disclosure. Configurations of a display device 600 according to still another exemplary embodiment of the present disclosure of FIG. 11 are the same as those of the display device 300 according to the exemplary embodiment of the present disclosure of FIG. 5 except for a gate driver GD so that a redundant description will be omitted.

Referring to FIG. 11, the gate driver GD of the display device 600 according to still another exemplary embodiment of the present disclosure may be implemented by a gate shift register configured by a plurality of stages. The plurality of stages may generate and output an output signal. The plurality of stages may receive an external start signal, a plurality of clock signals, a gate high voltage VGH which is a gate off voltage, and a gate low voltage VGL which is a gate on voltage to output the output signal. However, the present disclosure is not limited thereto and in the case of the n-type transistor, the gate high voltage VGH may be a gate on voltage and the gate low voltage VGL may be a gate off voltage. For example, referring to FIG. 11, the gate driver GD may be connected to a gate high voltage line VGHL which is supplied with a gate high voltage VGH and a gate low voltage line VGLL which is supplied with a gate low voltage VGL.

The plurality of stages are sequentially activated according to the start signal to output the output signal. The plurality of stages may be a plurality of scan driving stages and a plurality of emission driving stages.

However, in FIG. 11, for the convenience of description, the first stage ST1 of the gate driver GD is illustrated, but the stages may be repeatedly disposed in a column direction.

An operation of the first stage ST1 is activated according to an external start signal and operations of the second stage to the lowest stage are activated according to an output signal output from a previous stage. The output signal of the previous stage is an internal start signal and may be a carry signal. Here, the “previous stage” may refer to a stage which is located above a reference stage to generate an output signal which has a phase earlier than an output signal output from the reference stage.

The first stage ST1 may include an output signal generator OG and a buffer unit B.

The output signal generator OG may generate an output signal Gout through an external start signal, a plurality of clock signals, a gate high voltage VGH, and a gate low voltage VGL.

The buffer unit B may output the output signal Gout which is generated in the output signal generator OG. The buffer unit B may include a first buffer unit B1 and a second buffer unit B2.

The first buffer unit B1 may output a first output signal Gout1. For example, the first buffer unit B1 is connected to a first output line OL1 to output a first output signal Gout1 to a first output line OL1.

The second buffer unit B2 may output a second output signal Gout2 which is a shifted first output signal Gout1. For example, the second buffer unit B2 is connected to a second output line OL2 to output a second output signal Gout2 to a second output line OL2.

The display device 600 according to still another exemplary embodiment of the present disclosure includes a MUX unit MUX disposed between the plurality of output lines OL connected to the gate driver GD and the plurality of gate lines GL connected to the plurality of pixel groups PG. The MUX unit MUX includes a first MUX transistor MT1 which is connected between the output line OL and the first gate line GL1 and operates in response to the first MUX signal MS1 and a second MUX transistor MT2 which is connected between the output line OL and the second gate line GL2 and operates in response to the second MUX signal MS2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 600 according to still another exemplary embodiment of the present disclosure may supply the output signal Gout output from one stage ST to two gate lines GL through the MUX unit MUX as gate signals. Therefore, the number of stages disposed in the non-active area is reduced to ½ to increase the transparency and the degree of freedom of design of the bezel area and the gate signal may be applied to two pixel groups by one stage so that the PPI may be increased without adding a stage.

Further, in the display device 600 according to still another exemplary embodiment of the present disclosure, the first MUX transistor MT1 is connected between the output line OL connected to the gate driver GD and the first gate line GL1 and the second MUX transistor MT2 is connected between the output line OL and the second gate line GL2. Therefore, the first MUX transistor MT1 and the second MUX transistor MT2 operate in accordance with the first MUX signal MS1 and the second MUX signal MS2 to connect the output line OL to one of the first gate line GL1 or the second gate line GL2. Accordingly, the display device 600 according to still another exemplary embodiment of the present disclosure may apply the output signal output from one stage ST to two gate lines through the MUX unit MUX as gate signals so that the size of the gate driver disposed in the bezel area is minimized to minimize the bezel area.

The display device 600 according to still another exemplary embodiment of the present disclosure includes a switching unit SW disposed between the gate high voltage line VGHL and the plurality of gate lines GL. In the switching unit SW, a first switching transistor SW1 which operates in response to the second MUX signal MS2 is connected between the gate high voltage line VGHL and the first gate line GL1 and a second switching transistor SW2 which operates in response to the first MUX signal MS1 is connected between the gate high voltage line VGHL and the second gate line GL2. At this time, the first switching transistor SW1 and the second switching transistor SW2 operate in accordance with the first MUX signal MS1 and the second MUX signal MS2 to connect the gate high voltage line VGHL to one of the first gate line GL1 or the second gate line GL2. Accordingly, the display device 600 according to still another exemplary embodiment of the present disclosure supplies the gate high voltage VGH to the gate line GL to which the gate signal GS is not supplied through the switching unit SW to suppress erroneous operation of the pixel PX included in the pixel group PG. Therefore, an accurate operation is allowed to improve the image quality.

In the display device 600 according to still another exemplary embodiment of the present disclosure, a stage ST1 of the gate driver GD includes an output signal generator OG which generates the output signal Gout and a buffer unit B which outputs the output signal Gout generated in the output signal generator OG. The buffer unit B includes a first buffer unit B1 which is connected to the first output line OL1 to output the first output signal Gout1 and a second buffer unit B2 which is connected to the second output line OL2 to output the second output signal Gout2. Accordingly, the display device 600 according to still another exemplary embodiment of the present disclosure may output an output signal to one output signal generator OG and two buffer units of a first buffer unit B1 and a second buffer unit B2. Therefore, the number of output signal generators OG disposed in the non-active area is reduced to increase the transparency and the degree of freedom of design of the bezel area. Further, one output signal generator OG is used to apply the gate signal to two pixel groups so that the PPI may be increased without adding a stage and a size of the gate driver disposed in the bezel area is minimized to minimize the bezel area.

The exemplary embodiments of the present disclosure can also be described as follows:

According to an embodiment of the present disclosure, a display device includes a plurality of pixel groups including a plurality of pixels disposed in a row direction, a plurality of gate lines connected to the plurality of pixel groups, a gate driver which supplies an output signal, an output line connected to the gate driver and a plurality of MUX units connected between the plurality of gate lines and the output line.

The plurality of gate lines may include a plurality of first gate lines which is connected to a pixel group disposed in an odd-numbered row, among the plurality of pixel groups and a plurality of second gate lines which is connected to a pixel group disposed in an even-numbered row, among the plurality of pixel groups, and the plurality of MUX units may include a plurality of first MUX transistors connected between the plurality of first gate lines and the output line and a plurality of second MUX transistors connected between the plurality of second gate lines and the output line.

Each of the plurality of first MUX transistors may include a first electrode connected to the output line, a second electrode connected to the first gate line, and a gate electrode connected to a first MUX signal line which supplies a first MUX signal, and each of the plurality of second MUX transistors may include a first electrode connected to the output line, a second electrode connected to the second gate line, and a gate electrode connected to a second MUX signal line which supplies a second MUX signal.

A first MUX signal supplied to the plurality of first MUX transistors and a second MUX signal supplied to the plurality of second MUX transistors may alternately maintain a gate-on level.

A first MUX signal supplied to the plurality of first MUX transistors and a second MUX signal supplied to the plurality of second MUX transistors may maintain a gate-on level for one frame.

One frame may include a plurality of periods and the gate driver may output the output signal in each of the plurality of periods.

The display device may further include a gate-off signal line which supplies a gate-off signal and a switching unit connected between the gate-off signal line and the MUX unit.

The switching unit may include a first switching transistor connected between the gate-off signal line and the plurality of first MUX transistors and a second switching transistor connected between the gate-off signal line and the plurality of second MUX transistors.

The first switching transistor may include a first electrode connected to the gate-off signal line, a second electrode connected to the plurality of first gate lines, and a gate electrode connected to a second MUX signal line which supplies a second MUX signal, and the second switching transistor may include a first electrode connected to the gate-off signal line, a second electrode connected to the plurality of second gate lines, and a gate electrode connected to a first MUX signal line which supplies a first MUX signal.

The plurality of gate lines may include a plurality of first gate lines connected to a plurality of pixel groups disposed in a 3n-2-th (n is a positive integer), among the plurality of pixel groups, a plurality of second gate lines which is connected to a plurality of pixel groups disposed in a 3n-1-th row, among the plurality of pixel groups and a plurality of third gate lines which is connected to a plurality of pixel groups disposed in a 3n-th row, among the plurality of pixel groups, and the plurality of MUX units may include a plurality of first MUX transistors connected to the plurality of first gate lines, a plurality of second MUX transistors connected to the plurality of second gate lines and a plurality of third MUX transistors connected to the plurality of third gate lines.

The plurality of first MUX transistors may include a first electrode connected to the output line, a second electrode connected to the plurality of first gate lines, and a gate electrode connected to a 1-1-th MUX signal line which supplies a 1-1-th MUX signal, the plurality of second MUX transistors may include a first electrode connected to the output line, a second electrode connected to the plurality of second gate lines, and a gate electrode connected to a 2-1-th MUX signal line which supplies a 2-1-th MUX signal, and the plurality of third MUX transistors may include a first electrode connected to the output line, a second electrode connected to the plurality of third gate lines, and a gate electrode connected to a 3-1-th MUX signal line which supplies a 3-1-th MUX signal.

The 1-1-th MUX signal, the 2-1-th MUX signal, and the 3-1-th MUX signal may alternately maintain a gate-on level in one frame.

The display device may further include a gate-off signal line which supplies a gate-off signal and a switching unit connected between the gate-off signal line and the MUX unit, the switching unit may include a first switching transistor connected between the gate-off signal line and the plurality of first MUX transistors, a second switching transistor connected between the gate-off signal line and the plurality of second MUX transistors and a third switching transistor connected between the gate-off signal line and the plurality of third MUX transistors.

The first switching transistor may include a first electrode connected to the gate-off signal line, a second electrode connected to the plurality of first gate lines, and a gate electrode connected to a 1-2-th MUX signal line which supplies a 1-2-th MUX signal, the second switching transistor may include a first electrode connected to the gate-off signal line, a second electrode connected to the plurality of second gate lines, and a gate electrode connected to a 2-2-th MUX signal line which supplies a 2-2-th MUX signal, and the third switching transistor may include a first electrode connected to the gate-off signal line, a second electrode connected to the plurality of third gate lines, and a gate electrode connected to a 3-2-th MUX signal line which supplies a 3-2-th MUX signal.

The plurality of gate lines may include a plurality of first gate lines connected to a plurality of pixel groups disposed in a 4n-3-th (n is a positive integer), among the plurality of pixel groups, a plurality of second gate lines which is connected to a plurality of pixel groups disposed in a 4n-2-th row, among the plurality of pixel groups, a plurality of third gate lines which is connected to a plurality of pixel groups disposed in a 4n-1-th row, among the plurality of pixel groups and a plurality of fourth gate lines which is connected to a plurality of pixel groups disposed in a 4n-th row, among the plurality of pixel groups, and the plurality of MUX units may include a plurality of first MUX transistors connected to the plurality of first gate lines, a plurality of second MUX transistors connected to the plurality of second gate lines, a plurality of third MUX transistors connected to the plurality of third gate lines and a plurality of fourth MUX transistors connected to the plurality of fourth gate lines.

The plurality of first MUX transistors may include a first electrode connected to the output line, a second electrode connected to the plurality of first gate lines, and a gate electrode connected to a 1-1-th MUX signal line which supplies a 1-1-th MUX signal, the plurality of second MUX transistors may include a first electrode connected to the output line, a second electrode connected to the plurality of second gate lines, and a gate electrode connected to a 2-1-th MUX signal line which supplies a 2-1-th MUX signal, the plurality of third MUX transistors may include a first electrode connected to the output line, a second electrode connected to the plurality of third gate lines, and a gate electrode connected to a 3-1-th MUX signal line which supplies a 3-1-th MUX signal, and the plurality of fourth MUX transistors may include a first electrode connected to the output line, a second electrode connected to the plurality of fourth gate lines, and a gate electrode connected to a 4-1-th MUX signal line which supplies a 4-1-th MUX signal.

The 1-1-th MUX signal, the 2-1-th MUX signal, the 3-1-th MUX signal, and the 4-1-th MUX signal may alternately maintain a gate-on level in one frame.

The display device may further include a gate-off signal line which supplies a gate-off signal and a switching unit connected between the gate-off signal line and the MUX unit, the switching unit may include a first switching transistor connected between the gate-off signal line and the plurality of first MUX transistors, a second switching transistor connected between the gate-off signal line and the plurality of second MUX transistors, a third switching transistor connected between the gate-off signal line and the plurality of third MUX transistors and a fourth switching transistor connected between the gate-off signal line and the plurality of fourth MUX transistors.

The first switching transistor may include a first electrode connected to the gate-off signal line, a second electrode connected to the plurality of first gate lines, and a gate electrode connected to a 1-2-th MUX signal line which supplies a 1-2-th MUX signal, the second switching transistor may include a first electrode connected to the gate-off signal line, a second electrode connected to the plurality of second gate lines, and a gate electrode connected to a 2-2-th MUX signal line which supplies a 2-2-th MUX signal, and the third switching transistor may include a first electrode connected to the gate-off signal line, a second electrode connected to the plurality of third gate lines, and a gate electrode connected to a 3-2-th MUX signal line which supplies a 3-2-th MUX signal, and the fourth switching transistor may include a first electrode connected to the gate-off signal line, a second electrode connected to the plurality of fourth gate lines, and a gate electrode connected to a 4-2-th MUX signal line which supplies a 4-2-th MUX signal.

The gate driver may include an output signal generator which generates an output signal and a plurality of buffer units which is connected to the output signal generator to output the output signal.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. All the technical concepts in the equivalent scope of the present disclosure should be construed as falling within the scope of the present disclosure.

What is claimed is:

1. A display device comprising:
a plurality of pixel groups including a plurality of pixels disposed in a row direction;
a plurality of gate lines connected to the plurality of pixel groups;
a gate driver that supplies an output signal;
an output line connected to the gate driver; and
a plurality of multiplexor (MUX) units connected between the plurality of gate lines and the output line.

2. The display device according to claim 1, wherein the plurality of gate lines include:
a plurality of first gate lines that are connected to a pixel group from the plurality of pixel groups that is disposed in an odd-numbered row; and
a plurality of second gate lines that are connected to a pixel group from the plurality of pixel groups that is disposed in an even-numbered row, and
the plurality of MUX units include:
a plurality of first MUX transistors connected between the plurality of first gate lines and the output line; and
a plurality of second MUX transistors connected between the plurality of second gate lines and the output line.

3. The display device according to claim 2, wherein each of the plurality of first MUX transistors includes a first electrode connected to the output line, a second electrode connected to a first gate line from the plurality of first gate lines, and a gate electrode connected to a first MUX signal line that supplies a first MUX signal, and
each of the plurality of second MUX transistors includes a first electrode connected to the output line, a second electrode connected to a second gate line from the plurality of second gate lines, and a gate electrode connected to a second MUX signal line which supplies a second MUX signal.

4. The display device according to claim 2, wherein a first MUX signal supplied to the plurality of first MUX transistors and a second MUX signal supplied to the plurality of second MUX transistors alternately maintain a gate-on level.

5. The display device according to claim 2, wherein a first MUX signal supplied to the plurality of first MUX transistors and a second MUX signal supplied to the plurality of second MUX transistors maintain a gate-on level for one frame.

6. The display device according to claim 2, wherein one frame includes a plurality of periods and the gate driver outputs the output signal in each of the plurality of periods.

7. The display device according to claim 2, further comprising:
a gate-off signal line that supplies a gate-off signal; and
a switching unit connected between the gate-off signal line and a MUX unit from the plurality of MUX units.

8. The display device according to claim 7, wherein the switching unit includes:
a first switching transistor connected between the gate-off signal line and the plurality of first MUX transistors; and
a second switching transistor connected between the gate-off signal line and the plurality of second MUX transistors.

9. The display device according to claim 8, wherein the first switching transistor includes a first electrode connected to the gate-off signal line, a second electrode connected to the plurality of first gate lines, and a gate electrode connected to a second MUX signal line that supplies a second MUX signal, and
the second switching transistor includes a first electrode connected to the gate-off signal line, a second electrode connected to the plurality of second gate lines, and a gate electrode connected to a first MUX signal line that supplies a first MUX signal.

10. The display device according to claim 1, wherein the plurality of gate lines include:
a plurality of first gate lines connected to pixel groups from the plurality of pixel groups that are in a 3n-2-th row (n is a positive integer);
a plurality of second gate lines that are connected to pixel groups from the plurality of pixel groups that are in a 3n-1-th row; and
a plurality of third gate lines that are connected to pixel groups from the plurality of pixel groups that are in a 3n-th row, and
the plurality of MUX units include:
a plurality of first MUX transistors connected to the plurality of first gate lines;
a plurality of second MUX transistors connected to the plurality of second gate lines; and
a plurality of third MUX transistors connected to the plurality of third gate lines.

11. The display device according to claim 10, wherein the plurality of first MUX transistors includes a first electrode connected to the output line, a second electrode connected to the plurality of first gate lines, and a gate electrode connected to a 1-1-th MUX signal line that supplies a 1-1-th MUX signal,
the plurality of second MUX transistors includes a first electrode connected to the output line, a second electrode connected to the plurality of second gate lines, and a gate electrode connected to a 2-1-th MUX signal line that supplies a 2-1-th MUX signal, and
the plurality of third MUX transistors includes a first electrode connected to the output line, a second electrode connected to the plurality of third gate lines, and a gate electrode connected to a 3-1-th MUX signal line that supplies a 3-1-th MUX signal.

12. The display device according to claim 11, wherein the 1-1-th MUX signal, the 2-1-th MUX signal, and the 3-1-th MUX signal alternately maintain a gate-on level in one frame.

13. The display device according to claim 11, further comprising:
a gate-off signal line that supplies a gate-off signal; and
a switching unit connected between the gate-off signal line and a MUX unit from the plurality of MUX units,
wherein the switching unit includes:
a first switching transistor connected between the gate-off signal line and the plurality of first MUX transistors;
a second switching transistor connected between the gate-off signal line and the plurality of second MUX transistors; and
a third switching transistor connected between the gate-off signal line and the plurality of third MUX transistors.

14. The display device according to claim 13, wherein the first switching transistor includes a first electrode connected to the gate-off signal line, a second electrode connected to the plurality of first gate lines, and a gate electrode connected to a 1-2-th MUX signal line that supplies a 1-2-th MUX signal,
the second switching transistor includes a first electrode connected to the gate-off signal line, a second electrode connected to the plurality of second gate lines, and a gate electrode connected to a 2-2-th MUX signal line that supplies a 2-2-th MUX signal, and
the third switching transistor includes a first electrode connected to the gate-off signal line, a second electrode connected to the plurality of third gate lines, and a gate electrode connected to a 3-2-th MUX signal line that supplies a 3-2-th MUX signal.

15. The display device according to claim 1, wherein the plurality of gate lines includes:
a plurality of first gate lines that are connected to pixel groups from the plurality of pixel groups that are in a 4n-3-th row (n is a positive integer);
a plurality of second gate lines that are connected to pixel groups from the plurality of pixel groups that are in a 4n-2-th row;
a plurality of third gate lines that are connected to pixel groups from the plurality of pixel groups that are in a 4n-1-th row; and
a plurality of fourth gate lines that are connected to pixel groups from the plurality of pixel groups that are in a 4n-th row, and
the plurality of MUX units includes:
a plurality of first MUX transistors connected to the plurality of first gate lines;
a plurality of second MUX transistors connected to the plurality of second gate lines;
a plurality of third MUX transistors connected to the plurality of third gate lines; and
a plurality of fourth MUX transistors connected to the plurality of fourth gate lines.

16. The display device according to claim 15, wherein the plurality of first MUX transistors includes a first electrode connected to the output line, a second electrode connected to the plurality of first gate lines, and a gate electrode connected to a 1-1-th MUX signal line that supplies a 1-1-th MUX signal,
the plurality of second MUX transistors includes a first electrode connected to the output line, a second electrode connected to the plurality of second gate lines, and a gate electrode connected to a 2-1-th MUX signal line that supplies a 2-1-th MUX signal,
the plurality of third MUX transistors includes a first electrode connected to the output line, a second electrode connected to the plurality of third gate lines, and a gate electrode connected to a 3-1-th MUX signal line that supplies a 3-1-th MUX signal, and
the plurality of fourth MUX transistors includes a first electrode connected to the output line, a second electrode connected to the plurality of fourth gate lines, and a gate electrode connected to a 4-1-th MUX signal line that supplies a 4-1-th MUX signal.

17. The display device according to claim 16, wherein the 1-1-th MUX signal, the 2-1-th MUX signal, the 3-1-th MUX signal, and the 4-1-th MUX signal alternately maintain a gate-on level in one frame.

18. The display device according to claim 16, further comprising:
a gate-off signal line that supplies a gate-off signal; and
a switching unit connected between the gate-off signal line and a MUX unit from the plurality of MUX units,
wherein the switching unit includes:
a first switching transistor connected between the gate-off signal line and the plurality of first MUX transistors;
a second switching transistor connected between the gate-off signal line and the plurality of second MUX transistors;
a third switching transistor connected between the gate-off signal line and the plurality of third MUX transistors; and
a fourth switching transistor connected between the gate-off signal line and the plurality of fourth MUX transistors.

19. The display device according to claim 18, wherein the first switching transistor includes a first electrode connected to the gate-off signal line, a second electrode connected to the plurality of first gate lines, and a gate electrode connected to a 1-2-th MUX signal line which supplies a 1-2-th MUX signal,
the second switching transistor includes a first electrode connected to the gate-off signal line, a second electrode connected to the plurality of second gate lines, and a gate electrode connected to a 2-2-th MUX signal line that supplies a 2-2-th MUX signal, and
the third switching transistor includes a first electrode connected to the gate-off signal line, a second electrode connected to the plurality of third gate lines, and a gate electrode connected to a 3-2-th MUX signal line that supplies a 3-2-th MUX signal, and
the fourth switching transistor includes a first electrode connected to the gate-off signal line, a second electrode connected to the plurality of fourth gate lines, and a gate electrode connected to a 4-2-th MUX signal line that supplies a 4-2-th MUX signal.

20. The display device according to claim 1, wherein the gate driver includes:
an output signal generator configured to generate an output signal; and
a plurality of buffer units that are connected to the output signal generator, the plurality of buffer units outputting the output signal.
